(19) United States
(12) Patent Application Publication
(10) Pub. No.: US 2011/0066968 A1
(43) Pub. Date: Mar. 17, 2011

(54) Information system for healthcare and biology

(75) Inventors: Brian J. Goldsmith, Folsom, CA (US); Alan G. Maloney, San Francisco, CA (US); Paul Kelly, New York, NY (US); Frank Revi, San Francisco, CA (US)

(73) Assignee: Cogent Medicine a Delaware C-Corporation, San Francisco, CA (US)

(21) Appl. No.: 12/589,806

(22) Filed: Oct. 27, 2009

Related U.S. Application Data
(60) Provisional application No. 61/108,804, filed on Oct. 27, 2008.

(51) Int. Cl. G06F 17/30; G06F 3/048

(52) U.S. Cl. 715/781; 707/722; 707/E17.009

(57) ABSTRACT

This invention provides an information system about medicine and biology. The system organizes information about these subjects into a variety of classes and allows navigation through the information by displays that include links to related information. The links, when selected, provide links to other related information, allowing quick access to related information. In certain instances the information is displayed in a graphical representation. Selection of an icon representing an item in the graphical representation produces expert-curated information about the item, or links to it, and expert-curated information related to the item, for example, links to related information.

### CROSS-REFERENCE

This application claims the benefit of U.S. Provisional Application No. 61/108,804, filed Oct. 27, 2008, which application is incorporated herein by reference in its entirety.

### BACKGROUND OF THE INVENTION

The expanding knowledge base in the fields of healthcare and biology presents numerous problems to healthcare professionals and researchers. One problem is the increasing volume of information available that is often found scattered across multiple disciplines making it difficult for professionals and researchers to locate. Another problem is that access to information is often restricted by subscriptions or fees, hindering availability or stifling exploration of leads or ideas. Frequently, there are seemingly contradictory viewpoints or interpretation of experimental data, or competing theories to explain the data. Central to all of these problems is the large amount of time needed to stay abreast of current developments. Hence, healthcare professionals and researchers can feel ill informed of the latest developments in their field. Therefore, new ways are needed to consolidate, organize and present information that address the problems typically faced by healthcare professionals and scientists trying to stay abreast of medical and scientific developments.

### SUMMARY OF THE INVENTION

The present invention provides information systems and methods that display expert selected information and provide expert commentary. Access to information is facilitated through the aggregation and vetting of relevant information by experts in the field, but more importantly, users are provided with content developed by experts that is a synthesis of the available information and is presented in a intuitive manner. For healthcare practitioners, the graphic interfaces of the information system present expert developed, clinically intuitive representations of complex clinical pathways that educate the user and provide recommendations to consider in patient care management rather than dictate a generic diagnosis or treatment.

In some aspects of the invention, an information system is provided. The information system comprises a database comprising an information structure comprising information on subjects related to healthcare and/or biology; and an interface that produces a graphical representation of at least one subject in the information structure. The representation comprises at least one primary graphical element representing an item within the subject. Selection of the graphical element by a user produces both expert commentary on the item, and expert-curated information relating the item to the subject. The expert-curated information is in at least one of the following forms: a graphical representation, or textual or auditory presentation; a user selectable secondary graphical element which, if selected, displays additional information related to the item; or a linking element, which when selected, produces a secondary graphical representation, or a textual or auditory presentation from within or outside the information system. In further embodiments, the database is a relational database management system.

In some embodiments, the information on subjects related to healthcare information comprises information on at least one of dentistry, medicine, nursing, pharmacy, and physical therapy. In some embodiments, information on medicine further comprises information on pathophysiologies, diagnostic and/or prognostic tests, therapeutic modalities, treatment algorithms, and/or drug responsiveness. In some embodiments, information on pathophysiologies further comprises information on prepathologic conditions, malignancies, autoimmune diseases, infectious diseases, inflammatory diseases, psychiatric disorders, or neurological diseases.

In some embodiments, information on pathophysiologies further comprises information on conditions that predispose an individual to a pathophysiology, including the contribution of acquired or inherited genetic variance.

In some embodiments, information on malignancies further comprises information on pre malignant conditions and/or information on malignant conditions. In some embodiments, information on diagnostic and/or prognostic tests further comprises the assessment of biomarkers, standard laboratory tests, medical imaging, and/or physical examination.

In some embodiments, information on therapeutic modalities further comprises information on drugs, radiotherapy, surgery, transplantation, genetic therapy, psychiatric and other counseling, and/or physical therapy.

In some embodiments, information on drugs further comprises information on small molecules, biologics, natural products, and derivatives and combinations thereof.

In some embodiments, information on subjects related to biology comprises information on normal and abnormal cells, tissues, organs, organ systems, immunologic and cognitive/behavioral functions.

In some embodiments, at least one primary graphical representation produced by the interface is expert-curated. In some embodiments, the interface includes a graphical user interface. In one embodiment, the graphical representation produced by said interface is of a pathophysiology. In another embodiment, selection of a primary graphical element by a user produces expert-curated information relating to at least one of the following: the relation of the item represented by the graphical element to biomarkers; the relation of the item represented by the graphical element to the available and/or emerging diagnostic and/or prognostic tests; the relation of the item represented by the graphical element to available and/or emerging therapies; or the relation of the item represented by the graphical element to treatment algorithms for said pathophysiology.

In some embodiments, the graphical representation produced by the interface is of biomarkers. In some embodiments, the selection of a primary graphical element by a user produces expert-curated information relating to at least one of the following: the relation of the item represented by the graphical element to a pathophysiology; the relation of the item represented by the graphical element to available and/or emerging diagnostic and/or prognostic tests; the relation of the item represented by the graphical element to treatment algorithms; or the relation of the item represented by the graphical element to available and/or emerging therapies.

In some embodiments, the graphical presentation produced by the interface is of diagnostic and/or prognostic tests for a pathophysiology.

In some embodiments, the selection of a primary graphical element by a user produces expert-curated information relating to at least one of the following: the relation of the item represented by the graphical element to said pathophysiology; the relation of the item represented by the graphical element to biomarkers; the relation of the item represented by the graphical element to available and/or emerging therapies; or the relation of the item represented by the graphical element to treatment algorithms. In one embodiment, the graphical representation produced by the interface is of available and/or emerging therapies.

In some embodiments, selection of a primary graphical element by a user produces expert-curated information relating to at least one of the following: the relation of the item represented by the graphical element to a pathophysiology; the relation of the item represented by the graphical element to biomarkers; the relation of the item represented by the graphical element to diagnostic and/or prognostic tests; or the relation of the item represented by the graphical element to treatment algorithms. In one embodiment, the graphical representation produced by said interface is of treatment algorithms.

In some embodiments, the selection of a primary graphical element by a user produces expert-curated information relating to at least one of the following: the relation of the item represented by the graphical element to a pathophysiology; the relation of the item represented by the graphical element to biomarkers; the relation of the item represented by the graphical element to available and/or emerging diagnostic and/or prognostic tests; or the relation of the item represented by the graphical element to available and/or emerging therapies.

In some embodiments, the user selectable secondary graphical element in the produced expert-curated subject related information comprises further user selectable graphic elements comprising one or more of the following: a graphical representation, or textual or auditory presentation; a user selectable graphical element which, if selected, displays information relating to the item; or a linking element, which when selected, produces a tertiary graphical representation or textual or auditory presentation from within or outside the information system.

In some embodiments, an expert further comprises a person that performs research in the subject area and publishes in peer reviewed journals, lectures in this area, serves as a reviewer of journal articles in this area, and/or has an academic or clinical appointment in this area. In one embodiment, an expert further comprises a person who is board certified in the subject area.

In one aspect of the invention, a machine readable medium is provided comprising instructions that when executed by a machine cause the machine to perform operations including: displaying an interface with a graphical representation of at least one subject in the information structure, the representation comprising at least one primary graphical element representing an item within the subject, wherein selection of the graphical element by a user produces: expert commentary on the item, and expert-curated information relating the item to the subject. The expert-curated information comprises at least one of the following: a graphical representation or textual or auditory presentation; a user selectable secondary graphical element which, if selected, display(s) additional information related to the item; or a linking element, which when selected, produces a secondary graphical representation or textual or auditory presentation from within or outside the information system. The machine readable medium instructions further cause the machine to accept a selection request from a requester; and produce the expert commentary on the user selected graphical element and expert-curated information related to the subject.

In one aspect of the invention, a method is provided for obtaining information on subjects related to healthcare and/or biology. This method comprises providing a database comprising an information system comprising of an information structure comprising information on subjects relating to healthcare and/or biology; and an interface that produces a graphical representation of at least one subject in the information structure, the representation comprising at least one primary graphical element representing an item within the subject. Selection of the graphical element by a user produces expert commentary on the item, and expert-curated information relating the item to the subject. The expert-curated information is in at least one of the following forms: a graphical representation or textual or auditory presentation; a user selectable secondary graphical element which, if selected, display(s) additional information related to the item; or a linking element, which when selected, produces a secondary graphical representation, or textual or auditory presentation from within or outside the information system. The method further comprises accessing the information system; selecting a graphical element produced by said interface; and reviewing the produced expert commentary and expert-curated information.

In one aspect of the invention, a computer system display of information produced by an information system is provided comprising of a database comprising an information structure comprising information on subjects related to healthcare and/or biology; and an interface that produces a graphical representation of at least one subject in the information structure, the representation comprising at least one primary graphical element representing an item within the subject. Selection of the graphical element by a user produces expert commentary on the item, and expert-curated information relating the item to the subject in the form of at least one of the following: a graphical representation, or textual or auditory presentation; a user selectable secondary graphical element which, if selected, display(s) additional information related to the item; or a linking element, which when selected, produces a secondary graphical representation or textual or auditory presentation from within or outside the information system.

In one aspect of the invention a system is provided comprising of a first database comprising a plurality of items relating to a domain of medicine, wherein the items are organized in an ontology that comprises a plurality of first level classes consistent with the domain, each first level class containing items that share a common attribute consistent with the first level class; a second database comprising a map, wherein each of the item is connected to at least one other of the items by edges defining a relationship between the connected items; and an interface configured to display at least one element representing an item in the first database, wherein selection of the element causes display of elements representing items in the map to which the selected item is connected by an edge. In some embodiments, the organization of the ontology is constrained by an expert in the domain. In some embodiments, each item is associated with content relating to the subject and the content is constrained by an expert in the subject. In some embodiments, the domain of medicine is clinical medicine. In some embodiments, the domain of medicine is clinical personalized medicine.

In some embodiments, the ontology comprises a plurality of first level classes, wherein each first level class is consistent with the domain, and contains a plurality of second level classes that share a common attribute consistent with the first level class. In some embodiments, the first level classes include a plurality of subjects directed to medical specialties. In some embodiments, the medical specialties are selected from aerospace medicine, allergy and immunology, anesthesiology, behavioral medicine, cardiology, cardiothoracic surgery, colorectal surgery, community health, cosmetic and plastic surgery, critical care, dermatology, diving medicine, emergency medicine, endocrinology, epidemiology, family medicine, forensic science, gastroenterology, general surgery, geriatrics, hematology, internal medicine, medical oncology, microbiology, nephrology, neurology, neurosurgery, nuclear medicine, obstetrics-gynecology, occupational medicine, ophthalmology, orthopedics, otorhinolaryngology, pain management, palliative care, pathology, pediatric surgery, pediatrics, podiatry, psychiatry, pulmonary medicine, radiation oncology, radiology, rehabilitation medicine, rheumatology, rural health, sports medicine, thoracic surgery, toxicology, transplant surgery, trauma surgery, tropical health, urology, vascular surgery, and wilderness medicine.

In some embodiments, the first level classes include a plurality of subjects related to the practice of clinical medicine including at least one selected from disease diagnosis, pharmaceuticals, disease pathways, treatment modalities, biomarkers; molecular targets, drug mechanisms-of-action, drug mechanisms-of-toxicity, diagnostic patient management tests and prognostic patient management tests.

In some embodiments, the first level classes include at least drugs, disease diagnosis and biochemical pathway and an item in the drug class is connected to an item in the diagnosis class for which the drug is used, and is connected to an item in the biochemical pathway class that contain targets for the pharmaceutical.

In some embodiments, the first level classes include at least drugs, disease diagnosis and biochemical pathway and an item in the disease diagnosis class is connected to an item in the pharmaceutical class used in treatment of the disease, and is connected to an item in the biochemical pathway class that is involved in disease pathology.

In some embodiments, the first level classes include at least drugs, disease diagnosis and biochemical pathway and an item in the disease pathway class is connected to an item in the diagnosis class in which the pathway is implicated, and is connected to an item in the pharmaceutical class that target elements of the biochemical pathway.

In some embodiments, the selection of an element representing an item also displays information about the item. In some embodiments, the domain is personalized medicine and the information contains content directed to the understanding level of a clinician rather than to the understanding level of general public.

In some embodiments, the interface displays elements representing a plurality of the first level classes, wherein selecting an element that represents a first level class displays elements representing the items contained within the first level class. The elements representing the items contained within the first level class are displayed in a pull-down menu. In some embodiments, the interface displays elements representing a plurality of second level classes, wherein selecting an element representing a second level class displays elements representing the first level classes contained within the second level class. In some embodiments, the elements representing the primary classes contained within the second level class are displayed in a pull-down menu. In some embodiments, the elements representing related items, when selected, causes display of elements representing related items in a map in which the item of the selected element is the central node. In some embodiments, the display is a pop-up or roll over screen.

In one aspect of the invention, a method is provided comprising providing a first database comprising a plurality of items relating to a domain of medicine, wherein the items are organized in an ontology that comprises a plurality of first level classes consistent with the domain, each first level class containing items that share a common attribute consistent with the first level class; providing a second database comprising a map, wherein each of the item is connected to at least one other of the items by edges defining a relationship between the connected items; and providing an interface configured to display at least one element representing an item in the first database, wherein selection of the element causes display of elements representing items in the map to which the selected item is connected by an edge.

In one aspect of the invention a machine readable medium is provided comprising code that stores a first database comprising a plurality of items relating to a domain of medicine, wherein the items are organized in an ontology that comprises a plurality of first level classes consistent with the domain, each first level class containing items that share a common attribute consistent with the first level class; and code that stores a second database comprising a map, wherein each of the item is connected to at least one other of the items by edges defining a relationship between the connected items.

In some embodiments, the machine readable medium further comprises code that displays on an interface at least one element representing an item in the first database, wherein selection of the element causes display of elements representing items in the map to which the selected item is connected by an edge.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 is an exemplary user interface illustrating a home page of an information system of one or more embodiments of the present invention. A “Log-In” button links to the Log-in page that provides access to registered users to the website.

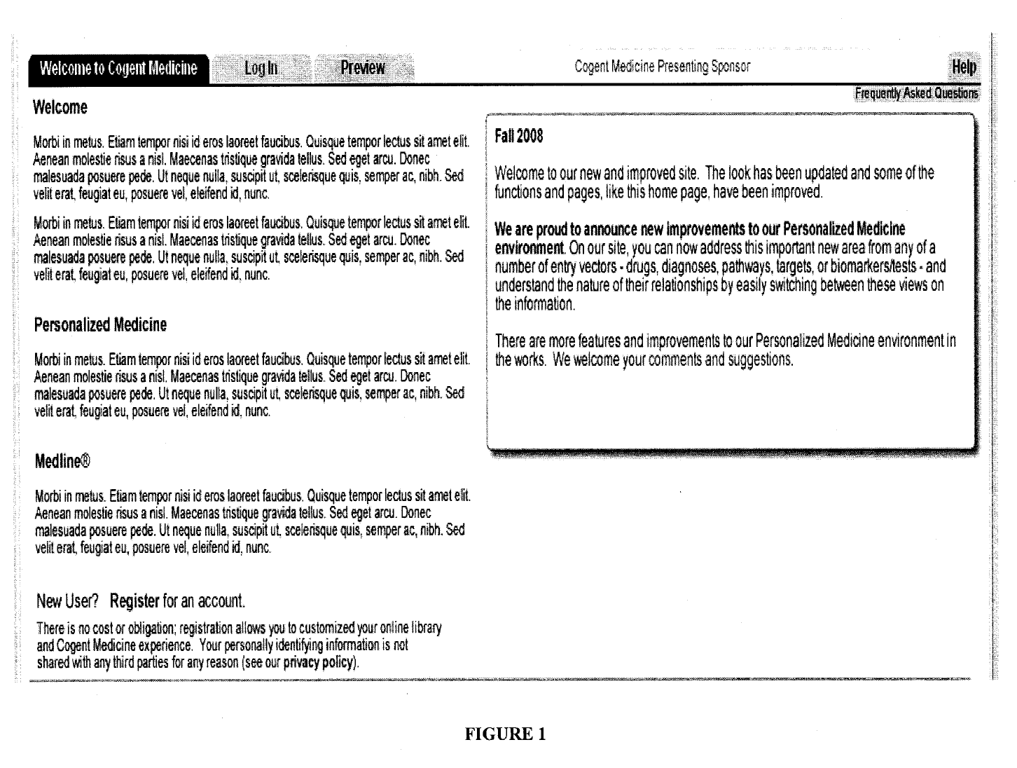

FIG. 2 is an exemplary user interface illustrating a Log-In page for registered users.

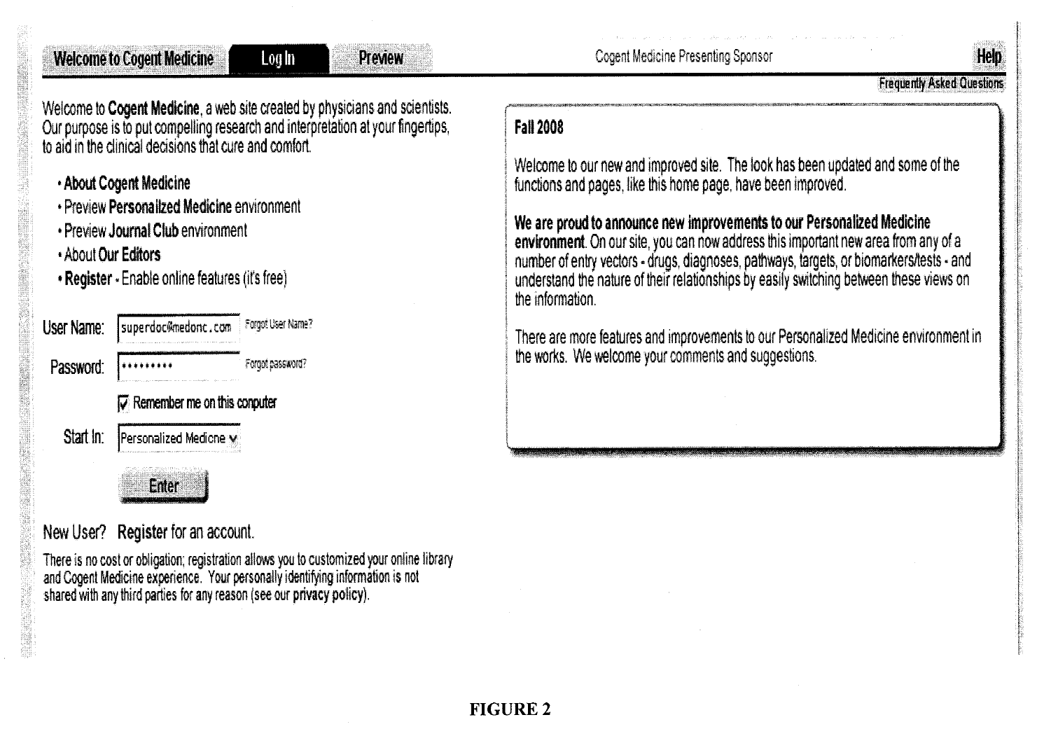

FIG. 3 is an exemplary user interface illustrating an entry page with buttons linking to a variety of different content sources. Selecting the “Personalized Medicine” button on the left side of the screen displays a number of topics including Medical Oncology, Radiation Oncology, and Psychiatry. Additionally, an information box can provide expert commentary on personalized medicine and the specialty groups or topics found within Personalized Medicine.

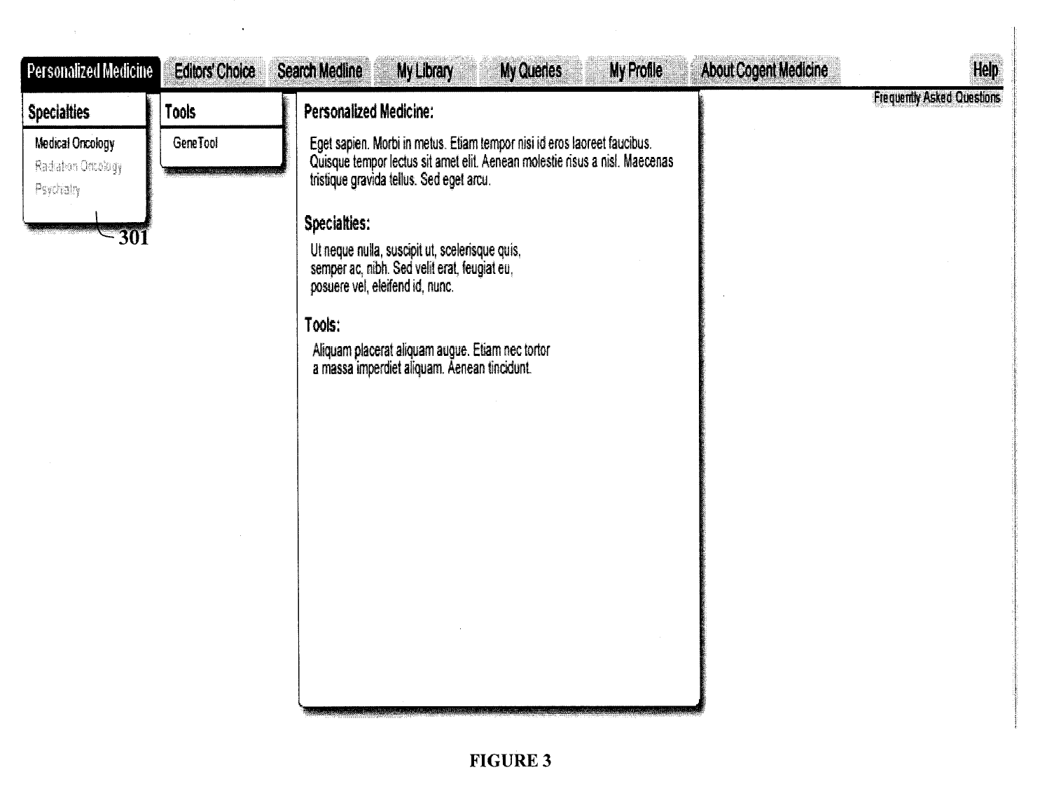

FIG. 4 is an exemplary user interface illustrating the screen display after the selection of the “Medical Oncology” icon listed under Personalized Medicine. Various icons representing first level classes within the ontology of Medical Oncology are displayed horizontally across the screen. These include “Drugs”, “Diagnoses”, “Pathways”, “Targets”, “Mechanisms”, and “Biomarkers/Tests.” In this particular embodiment, selection of the Medical Oncology icon produces not only the first level classes but also the items found within each class.

FIG. 5 is an exemplary user interface illustrating the screen display when the icon representing class “Drugs” is selected on the left side of the screen. The listed drugs have some relation to personalized medicine. The listed drugs are further categorized by as to whether the drug is a targeted drug or a conventional drug whose use may be guided by molecular testing. These drugs are further categorized by generic and brand name. Generally, the listed drugs are linked to displays of that provide further drug information. In the center of the screen display is a drop-down chart with icons for each of the first level classes: “Drugs”, “Diagnoses”, “Pathways”, “Targets”, “Mechanisms”, and “Biomarkers/Tests.” Additionally, the first level classes are also accessible through the bold designations “Drugs”, “Diagnoses”, “Pathways”, “Targets”, “Mechanisms”, and “Biomarkers/Tests” listed across the upper middle of the display. Also displayed on the right side of the screen is an information box with expert-curated information about approved targeted drugs and conventional agents.

FIG. 6 is an exemplary user interface illustrating the screen display after the icon representing the drug “Bevacizumab” (Avastin®) is selected from the list of approved targeted drugs. In the center of the screen a pull-down menu displays those items in the various first level classes that are linked in the map to Bevacizumab, FIG. 32. Each of these items is, in turn, selectable. Also displayed on the right side of the screen is an information box that provides expert-curated information about the selected drug, in this case Bevacizumab.

FIG. 7 is an exemplary user interface illustrating the screen display after the icon representing “Diagnoses—Breast Cancer” is selected from the pull-down menu presented in the center of the Bevacizumab page. On the right side of the screen is displayed an information box with expert-curated information related to the use of the Bevacizumab for breast cancer, as well as information about other drugs that should be considered for use to treat the disease.

FIG. 8 is an exemplary user interface illustrating the screen display after the icon representing “Pathways—VEGFR” is selected from the pull-down menu presented in the center of the Bevacizumab page. This produces on the right side of the screen an information box with links to expert commentary and expert-curated information related to other drugs in clinical trials that have the same mechanism of action in the VEGFR pathway.

FIG. 9 is an exemplary user interface illustrating the screen display after the icon representing “Targets”—“VEGF” is selected from the pull-down menu presented in the center of the Bevacizumab page. This produces on the right hand of the screen an information box with expert-curated information about the targets of Bevacizmab.

FIG. 10 is an exemplary user interface illustrating the screen display after the icon representing “Mechanisms—Anti-angiogenic” is selected from the pull-down menu on the center of the Bevacizumab page. This produces on the right hand of the screen an information box that contains links to expert-curated information and/or expert-selected articles about the anti-angiogenic mechanism of Bevacizumab. Also provided are links to other targeted drugs that share the same mechanism of action as Bevacizumab and happen to be undergoing clinical trials.

FIG. 11 is an exemplary user interface illustrating the screen display after the icon representing class “Diagnoses” is selected. A list of selectable diagnoses is displayed on the left side of the screen. Adjacent to the diagnoses Breast Cancer is a selectable link to an interactive treatment algorithm designated by the icon “T.” Displayed in the center of the screen is a drop-down chart with selectable icons for each of the first level classes: “Drugs”, “Diagnoses”, “Pathways”, “Targets”, “Mechanisms”, and “Biomarkers/Tests.”. Additionally, an information box is displayed on the right side of the screen that contains expert commentary about diagnoses as they relate to personalized medicine.

FIG. 12 is an exemplary user interface illustrating the screen display after the icon representing “Diagnosis—Breast Cancer” is selected. A selectable icon “T” on the left side of the screen leads to an interactive treatment algorithm. This page displays in the center of the screen a pull-down menu of those items in the various first level classes that are linked to Breast Cancer. Each of these is, in turn, selectable. The selection of Breast Cancer from the listing of diseases on the left side of the screen also produces in the information box on the right side of the screen expert commentary about diagnosing and treating breast cancer. Additionally, expert-curated information about breast cancer is displayed including a link to an interactive treatment algorithm for breast cancer and expert selected citations of articles on breast cancer diagnosis and treatment. Links to information on clinical trials for the treatment of breast cancer are also provided.

FIG. 13 is an exemplary user interface illustrating the screen display after one of the icons representing “Treatment Algorithm” is selected from the “Diagnosis—Breast Cancer” page shown in FIG. 12. This treatment algorithm can be accessed by either selecting the “T” icon to the right of the “Breast Cancer” icon shown in the list of diseases on the left side of the screen or by clicking on the partial treatment algorithm diagram icon displayed in the information box on the right side of the screen in FIG. 12. Each of the elements in the treatment algorithm may be selectable. When a selectable element is chosen expert commentary and expert-curated information about the element is displayed in an information box

FIG. 14 is an exemplary user interface illustrating the screen display after the icon representing “Drugs” is selected from the first level classes in the context of Diagnosis—Breast Cancer. This page displays in the pull-down menu in the center of the screen drugs useful for treating breast cancer including targeted drugs that are approved for breast cancer treatment, targeted drugs that are approved for other indications, but are undergoing clinical testing for the treatment of breast cancer and conventional agents for which their use can be guided by molecular testing. Each of these drugs is, in turn, selectable. On the right side of the screen is provided a table with more information about the listed drugs. This table has further selectable elements for each drug that may include links to the generic and/or brand name versions of the drug, mechanisms of action, drug targets, biologic pathways targeted by the drugs, and available tests for the selection and/or monitoring of patients.

FIG. 15 is an exemplary user interface illustrating the screen display following the selection of the zoom feature located in the upper right side of the screen. Here, the table originally shown in FIG. 14 is now enlarged to facilitate reading of the table and the selection of links. Selection of the “Zoom Out (−)” icon will return the display to its former size as seen in FIG. 14.

FIG. 16 is an exemplary user interface illustrating the screen display after the icon representing “Bevacizumab” is selected in the context of Diagnosis—Breast Cancer-Drugs. An information box is displayed on the right side of the screen that contains expert commentary on Bevacizumab. Additionally, links are provided to various first level classes that relevant to Bevacizumab in the context of Breast Cancer i.e., Pathways, Targets, Mechanisms and Biomarkers/Tests. Further links provide access to additionally expert commentary and/or expert-selected citations on Bevacizumab and also to information on clinical trials of Bevacizumab for the treatment of breast cancer.

FIG. 17 is an exemplary user interface illustrating the screen display after the icon representing class “Pathways” is selected in the context of the Diagnosis—Breast Cancer. Displayed in the center of the screen is a drop-down menu with selectable icons for each of the first level classes. In the class Pathways information is presented about pathways that have some relation to personalized breast cancer treatment. Additionally, displayed in the information box on the right side of the screen is expert commentary about pathways and/or expert-selected citations to relevant articles and links to clinical trials using the drugs that target the specific pathways listed. Additionally, a table is included with selectable links for relevant pathways and both the generic and brand names of the drugs that target these pathways.

FIG. 18 is an exemplary user interface illustrating the screen display after the icon representing the “VEGFR” Pathway is selected from the pathways listed in the pull-down menu in the center of the screen under the first level class Pathways. This page displays in the pull-down menu those items in the various first level classes that are linked to VEGFR pathway, including items that are connected in the map having VEGFR pathway as a central node. Each of these is, in turn, selectable. The information box displayed on the right side of the screen shows expert commentary about the VEGFR pathway as well as expert-curated information in the form of a graphical representation of the pathway. A link is provided that takes the user to more detailed and interactive VEGFR pathway diagram. Also provided are links to further expert commentary and/or expert-selected citations about the VEGFR pathway as it relates to breast cancer. Additional links are given to clinical trials of drugs that target the VEGFR pathway in breast cancer.

FIG. 19 is an exemplary user interface illustrating the screen display after the icon representing “Targets” is selected from the first level of classes in the context of Diagnosis—Breast Cancer. On the center of the screen, the pull-down menu lists those targets that are relevant to the treatment of breast cancer, each of which is selectable. When Targets is selected from the pull down menu, information about Targets that relate to breast cancer treatment is displayed in the information box on the right side of the screen. Included is expert-commentary about targets as they relate to the personalized medicine treatment of breast cancer, plus links to further expert commentary and/or expert-curated and expert-selected citations about breast cancer targets. Additionally, there a links to clinical trials of drugs that target cell signaling pathways in breast cancer. Also provided is a table of breast cancer targets that includes selectable links for the targets, specific pathways that contain one or more targets, and drugs useful for treating breast cancer where one or more cell signaling pathway are dysregulated.

FIG. 20 is an exemplary user interface illustrating the screen display after the icon representing “VEGF” is selected in the context of Targets in the context of Diagnosis—Breast Cancer. When VEGF is selected from the pull down menu in the center of the display an information box about is displayed on the right side of the screen that contains expert commentary about VEGF and information about the first level classes as they relate to VEGF. Selectable links to may be present for specific first level classes. Additionally, links to further expert commentary and/or expert selected and expert curated citations are provided along with links to clinical trials of drugs that target VEGF in breast cancer.

FIG. 21 is an exemplary user interface illustrating the screen display after the icon representing “Mechanism” is selected in the context of Diagnosis—Breast Cancer. This page displays in the center a pull-down menu of those items in the various first level classes that are linked to Mechanisms in the context of Breast Cancer. Here, there are four items listed directly under Mechanisms: Anti-Angiogenic, Anti-Metastatic, Anti-Proliferative, and Pro-Apoptotic. Each of these is, in turn, selectable. When Mechanisms is selected from the pull down menu, an information box is displayed on the right side of the screen. Included is expert commentary about breast cancer drug mechanisms of action along with links to further expert commentary and/or expert-curated citations relevant to drug mechanisms of action in the context of the treatment of breast cancer. Also provided is a table of approved drugs, both generic and brand names and drugs in clinical trials by generic and brand names. These drugs are further grouped by drug mechanisms of action. Individual elements of the table are selectable links that may be chosen if the user desires further information on that particular item.

FIG. 22 is an exemplary user interface illustrating the screen display after the icon representing “Anti-Angiogenesis” is selected in the context, of Mechanisms in the context of the Diagnosis—Breast Cancer. An information box appears on the right side of the display that features expert commentary about anti-angiogenic mechanisms of action of drugs in the context of the personalized medicine treatment of breast cancer. Additionally, a link is provided to individual anti-angiogenic drugs, Also links are provided for access to further expert commentary and/or expert-curated citations to peer-reviewed publications, and clinical trials of breast cancer drugs that have anti-angiogenesis as a mechanism of action.

FIG. 23 is an exemplary user interface illustrating the screen display after the icon representing “Biomarkers/Tests” is selected in the context of Diagnosis—Breast Cancer. This page displays in the pull-down menu in the center of the page those items in the various first level classes that are linked to Biomarkers/Tests in the context of Breast Cancer. Each of these items is, in turn, selectable. When Biomarkers/Tests is selected from the pull down menu, an information box appears on the right side of the screen. Here, expert commentary is provided on biomarkers and/or tests for breast cancer along with links to further expert commentary and/or expert-curated citations to publications. Additionally, an expert-curated table of breast cancer biomarkers and/or tests is provided that includes the type of test, the drugs that are relevant to the individual test, the name of the individual biomakers, the genes that are related to the biomarker, and vendors or service providers of the tests. The tests are further subdivided based on whether the tests are diagnostic, prognostic, provide other patient management information, or provide information on whether a specific drug is useful in treating a particular patient.

FIG. 24 is an exemplary user interface illustrating the screen display after the icon representing “FISH Panel” is selected in the context of Biomarkers/Tests in the context of Diagnosis—Breast Cancer. When FISH Panel is selected from the pull down menu, an information box appears on the right side of the screen. Expert commentary is provided on the use of FISH. Additionally links are provided to access further expert commentary and/or expert-curated citations to relevant publications. Other links provide information about specific drugs for which FISH analysis can provide useful patient treatment information.

FIG. 25 is an exemplary user interface illustrating the screen display after the icon representing class “Pathways” is selected. The information presented about the pathways have some relation to personalized medicine. Displayed on the left side of the screen is a list of selectable cell signaling pathways, each of which has an associated and selectable “P” symbol that is a link to a chart of the pathway. In the middle of the screen is displayed a drop down menu of the first level classes that have related information on pathways. On the right hand side of the screen is an information box that provides expert commentary about pathways and instruction on how to find more details on a particular pathway of interest.

FIG. 26 is an exemplary user interface illustrating the screen display after the icon representing “VEGFR” is selected from the list of displayed pathways. The information box on the right hand side of the screen provides expert commentary on the VEGFR pathway, links to further expert commentary and/or expert curated publications, and links to clinical trials of drugs for the treatment of cancers that have a dysregulated VEGFR signaling pathway. Additionally, an expert-curated graphical representation of the VEGFR pathway is illustrated. A more detail and interactive graphical representation can be accessed by clicking on the pathway diagram or by selecting the “P” icon adjacent to VEGFR in the list of pathways.

FIG. 27 is an exemplary user interface illustrating the screen display after either the graphical representation of the VEGFR pathway in the information box shown in FIG. 26 or the icon representing the VEGFR pathway that is adjacent the listing of “VEGFR” in the drop-down menu of pathways is selected. This expert-curated graphical representation of the VEGFR pathway has more detail than the representation shown in the FIG. 26 and includes selectable elements that provide further information on the selected item. Additional information can be obtained through this manner for such items as drugs that inhibit components of the VEGFR signaling pathway, the drugs mechanism of action, and testing for biomarkers. The information block on the right provides expert commentary on the VEGFR pathway and provides a link to return to the main VEGFR Pathway page.

FIG. 28 is an exemplary user interface illustrating the screen display after the icon representing class “Targets” is selected. On the left of the screen is displayed a list of drug targets and their associated aliases, if applicable. The information presented about the targets have some relation to personalized medicine. Additionally, in the center of the screen a drop-down menu with icons for the first level class members displayed. Furthermore, an information box is displayed on the right side of the screen that presents expert commentary about targets and their relation oncology.

FIG. 29 is an exemplary user interface illustrating the screen display after the icon representing “VEGF” is selected from the items displayed in the Targets panel on the left side of the screen. Additionally, in the center of the screen a drop-down menu with icons for the first level class members are displayed. Each of these icons is selectable. Furthermore, an information box is shown on the right side of the screen that presents expert commentary about VEGF as it relates to oncology. This page also displays in the pull-down menu those items in the various first level classes that are linked to VEGF, including items that are connected in the map having VEGF as a central node.

FIG. 30 is an exemplary user interface illustrating the screen display after the icon representing “Mechanisms” is selected. A list of mechanisms of action for cancer therapy drugs is displayed on the left side of the screen. Also displayed in the center of the screen is a drop-down list of the first level classes, each of which is selectable. Additionally, an information box is displayed on the right side of the screen that contains expert commentary about mechanisms of action for personalized medicine drugs.

FIG. 31 is an exemplary user interface illustrating the screen display after the icon representing “Anti-angiogenic” is selected from the items displayed in the “Mechanisms” drop down menu on the left side of the screen. Also displayed in the center of the page is another pull-down menu containing those items in the various first level classes that are linked to the mechanism, Anti-angiogenesis, including items that are connected in the map having Anti-angiogenic as a central node. Each of these items is, in turn, selectable. Additionally, an information box is displayed on the right side of the screen that contains expert commentary about anti-angiogenesis as it relates to oncology.

FIG. 32 shows a network map of select items in the ontology that are related to one another. This map shows edges connecting a subset of items in the ontology. In a complete map, each item in the ontology would be linked to at least one other item.

FIG. 33 illustrates the enlarged and interactive VEGFR pathway that can be accessed through clicking on the graphical representation of the pathway shown in FIG. 18 or FIG. 26, or by selecting the “P” icon shown in FIG. 26. Additionally, on the right side of the screen an information box is displayed that contains expert commentary on the VEGFR pathway, links to Bevacizumab (FIG. 6) and the VEGFR pathway main page (FIG. 26), links to expert-curated references and a link to a manufacture's website.

FIG. 34 illustrates the expert commentary and expert-curated information produced after scrolling over, clicking on or otherwise selecting the active graphical element that is represented by the diamond symbol entitled “Her-2 Over-Expressed, Node positive” shown in FIG. 13. On the right side of the screen, expert commentary on Her-2 over-expression is provided along with expert-curated citations to publications that are relevant to Her-2 and/or fluorescent in situ hybridization (FISH) analysis testing. Additionally, links to the VEGFR pathway (FIG. 27) and relevant drugs (FIG. 7) for the treatment of Her-2 positive breast cancer are given along with a link to a FISH testing laboratory.

FIG. 35 illustrates a computer system for use in practicing the instant invention.

FIG. 36 illustrates expert commentary and an expert-curated citation relevant to personalized medicine. In this case, a citation to a publication of a phase II study on the treatment of colorectal cancer with the targeted therapeutic Bevacizumab is provided along with expert commentary on the study.

FIG. 37 illustrates an alternate exemplary Breast Cancer Treatment Algorithm display presented to a user after one of the icons representing “Treatment Algorithm” is selected from the “Diagnosis—Breast Cancer” page shown in FIG. 12. This treatment algorithm can be accessed by either selecting the “T” icon to the right of the “Breast Cancer” icon shown in the list of diseases on the left side of the screen or by clicking on the partial treatment algorithm diagram icon displayed in the information box on the right side of the screen in FIG. 12. Each of the elements in the treatment algorithm may be selectable. When a selectable element is chosen expert commentary and expert-curated information about the element is displayed in an information box

FIG. 38 illustrates an exemplary screen display presented to a user after the HER2-negative Metastatic icon in the treatment algorithm is clicked. The information box provides expert commentary on the prevalence of HER2(ErbB2/HER2) negative breast cancers along with the diagnosis criteria for the defining a breast cancer specimen as negative. Links are provided to biomarkers, genes, related pathways and diagnostic tests. Additionally, a link back to the Breast Cancer main page is also provided.

FIG. 39 is an alternate exemplary user interface illustrating the screen display after either the graphical representation of the VEGFR pathway in the information box shown in FIG. 26 or the “P” icon representing the VEGFR pathway that is adjacent the listing of “VEGFR” in the drop-down menu of pathways is selected. This graphical representation of the VEGFR pathway has more detail than the representation shown in the FIG. 26 and includes selectable elements that provide further information on the selected item. Additional information can be obtained through this manner for such items as drugs that inhibit components of the VEGFR signaling pathway, the drugs mechanism of action, and testing for biomarkers.

FIG. 40 is an exemplary user interface illustrating the screen display after the icon representing drug #4 is hovered over with the cursor. On the left of the screen, a box is displayed that identifies drug #4 as Sunitnib Malate (SUTENT). Additionally, a link is provided to the Sunitnib Malate page in the first class “Drugs.” As an alternative, the user is provided with instructions to obtain further information on Sunitnib Malate by clicking on the icon of drug #4. If the icon is selected, information can be provided on Sunitnib Malate through an information box display, without navigating away from the current page.

### DETAILED DESCRIPTION OF THE INVENTION

### 1. Introduction

The present invention is an information system for healthcare professionals and biologists. The information system provides the users with expert developed and expert-curated information so that they can make informed decisions, in particular, clinical decisions. The information system contains structured information on various healthcare and biology disciplines. This information is provided to the user through a system interface that presents to the user a graphical representation of a subject. The graphical representation is composed of at least one primary graphical element that is selectable by the user. In some embodiments, at least one, two, three, four, five, six, seven, eight, nine, ten, eleven, twelve, thirteen, fourteen, fifteen, or twenty primary graphical elements are displayed. When a graphical element is selected, the information system presents to the user expert commentary on the item represented by the graphical element and the relation of the item to the subject matter.

Additionally, expert-curated information that relates the item to the subject is also produced by the information system. This is presented to the user in at least one of three possible forms. The first form is at least one graphical representation, or a textual or auditory presentation. In some embodiments, at least two, three, four, five, six, seven, eight, nine, ten, eleven, twelve, thirteen, fourteen, fifteen, or twenty graphical representations, or textual, or auditory presentations are presented or presentable. The second form is at least one user selectable secondary graphical element that upon selection displays additional information related to the initial item. In some embodiments, at least two, three, four, five, six, seven, eight, nine, ten, eleven, twelve, thirteen, fourteen, fifteen, or twenty secondary graphical elements are displayed. The third form is at least one linking element that upon selection displays a secondary graphical representation, or a textual or auditory presentation. In some embodiments, at least two, three, four, five, six, seven, eight, nine, ten, eleven, twelve, thirteen, fourteen, fifteen, or twenty linking elements are displayed. This material can be content that is housed in the information system or it can be content housed outside the information system, such as a website of an advertiser.

The user can easily navigate the system because items are linked to related items. When an item is selected, related items are displayed. Selection of any one of these displayed, related items, will in turn, display additional items that relate to this second, selected item. Any one of these additional items can then be selected, producing a further (third) display of items that relate to the most recently selected item from the second display. A user can continue in this manner following relationships to learn more about specific items and how they relate to earlier displayed items. All linkages between items allow forward and backward movement, so if a user believes the relation path is not so pertinent to the user's needs or interest, the user can quickly backtrack to the original point of divergence. Frequently, due to the interrelated nature of the various subject matter, a user can walk links through related subject matter to arrive back at the original point of departure, if desired. Usually, a link is also provided to the original subject heading, or to the most recent subject heading, so that the user can easily jump up back to broader subject matter.

The items can be arranged according to an ontology that groups items with common attributes together in a class. The classes together can be organized as branches of a common concept, such as medical oncology. The interface allows both nested searches and direct navigation to alternate branches of nested searches. Nested searches are performed when selection of an icon at one class level of the ontology displays all the sub-items grouped within the class. Branched searches are performed when selection of an icon representing an item or instance in the data structure displays other items that related to the selected item according to some defined relationship. Accordingly, the user is not limited to going up and down a single branch, but can move from one branch to another without having to return to the common branch point.

### 2. Information System

The information system comprises of two components, an information structure that houses the information in an organized and searchable arrangement and an interface that allows a user to access the housed information.

2.1 Components of the Information Structure

The information structure comprises information on subjects related to healthcare and/or biology. The information structure resides in a group of electronic resources designed and configured for the collection, storage, organization, maintenance, and presentation of information in a useful way. The electronic resources include, for example, computers, computer peripherals, computer network infrastructure, software in the form of operating systems and database systems, web servers, and custom or off the shelf software applications.

In some embodiments, the information structure comprises a computer database. Numerous types of database structures can be used in the present invention including hierarchical, networked or relational database management systems. The database structure can be on any appropriate platform, for example, the UNIX operating system, a UNIX derived operating system such as FreeBSD, Solaris, or Linux, a Windows operating system or an Apple operating system. The appropriate database may be housed on one or more a standard servers, for example, a Dell PowerEdge™.

The information structure contains the content, plus a particular conceptual organization and arrangement of the data. The information structure allows the ability to create, modify, and remove data housed within the information structure, thereby allowing the information structure to be maintained and updated. The information structure further includes ways to access and process the stored data elements. The information structure, additionally allows the querying of the relationships of the stored data and the display of the query results. Examples of the information structure components that are included in this invention comprise tables, stored procedures, computer code, file structures, documents, descriptions, instructions, and documentation for users.

2.2 Organization of the Information

The information contained in the system can be organized into an ontology and further organized as a map.

2.2.1 Ontology

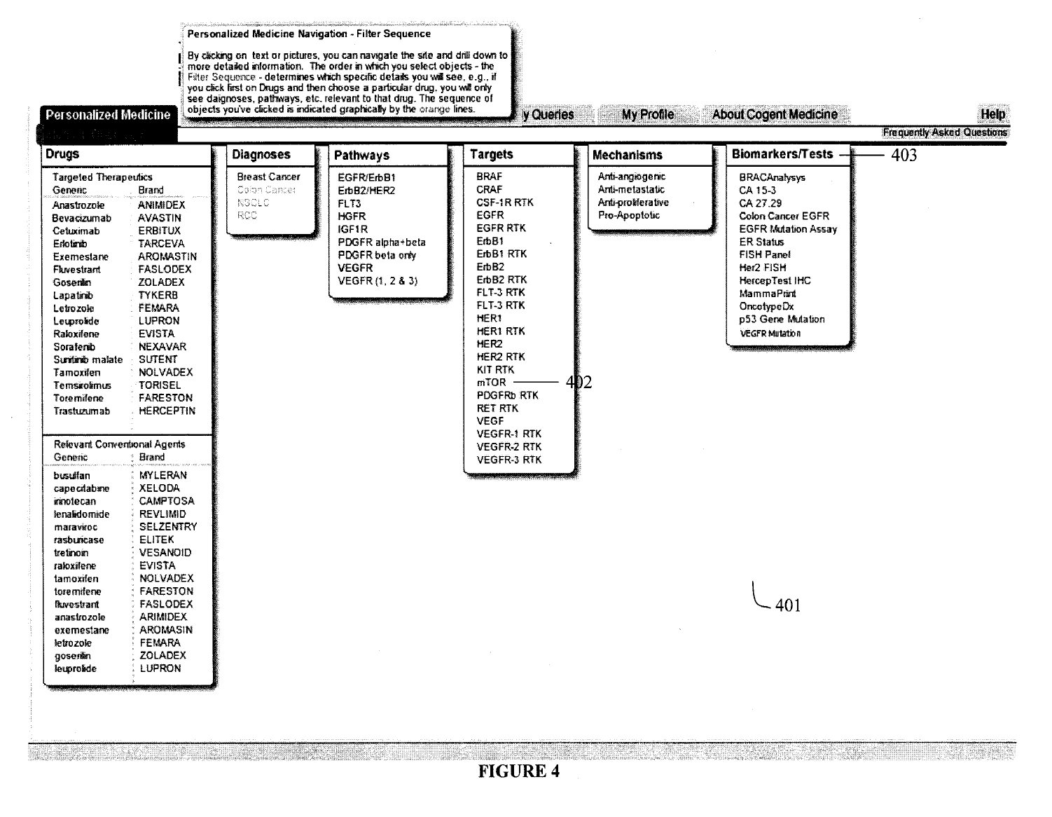

An ontology is typically comprised of “individuals” that represent single things or elements, and “classes” that represent a group of things or elements that share one or more similar properties. Referring to FIG. 4, for example, Trastuzumab is an item that is also a member of the class of “Drugs.” Similarly, VEGF is an item and is also a member of the class of “Targets.” Items can be members of more than one class or subclass. Classes can be described it terms of being a subclass or supra-class of a particular class or alternately, in terms of class level. Taking Medical Oncology as the domain that encompasses all classes, “Drugs”, “Diagnoses”, “Pathways”, “Targets”, “Mechanisms” and “Biomarkers/Tests” represent first level classes of “Medical Oncology.” “Drugs” comprises of drugs or pharmaceutical compositions used in medical oncology. “Diagnoses” comprises specific conditions or diseases. “Pathways” relate to the molecular or biochemical interactions that play a role in malignances. “Targets” show molecular targets for personalized medicine treatment. Various drugs may interact directly with a target, or the drugs may inhibit part of the cell signal transduction pathway for which the target is a member. “Mechanisms” relates to drug mechanisms-of-action that produces a therapeutic effect. “Biomarkers/Tests” relates to molecules that can be used classify the disease state of an individual. Optionally, Biomarkers/Tests could be represented by separate classes for diagnostic, prognostic, and drug selection biomarkers or tests.

In the domain of medicine, classes of medical specialties include aerospace medicine, allergy and immunology, anesthesiology, behavioral medicine, cardiology, cardiothoracic surgery, colorectal surgery, community health, cosmetic and plastic surgery, critical care, dermatology, diving medicine, emergency medicine, endocrinology, epidemiology, family medicine, forensic science, gastroenterology, general surgery, geriatrics, hematology, internal medicine, medical oncology, microbiology, nephrology, neurology, neurosurgery, nuclear medicine, obstetrics-gynecology, occupational medicine, ophthalmology, orthopedics, otorhinolaryngology, pain management, palliative care, pathology, pediatric surgery, pediatrics, podiatry, psychiatry, pulmonary medicine, radiation oncology, radiology, rehabilitation medicine, rheumatology, rural health, sports medicine, thoracic surgery, toxicology, transplant surgery, trauma surgery, tropical health, urology, vascular surgery, and wilderness medicine.

In some embodiments, the ontology comprises at least two, three, four, five, six, seven, eight, nine, ten, fifteen or twenty levels of classes. Ontologies can further comprise of “slots” that represent relationships between items, “facets” that represent detailed information about the slots, and “relations” that represent detailed relationships between the items, and other information.

2.2.2 Map

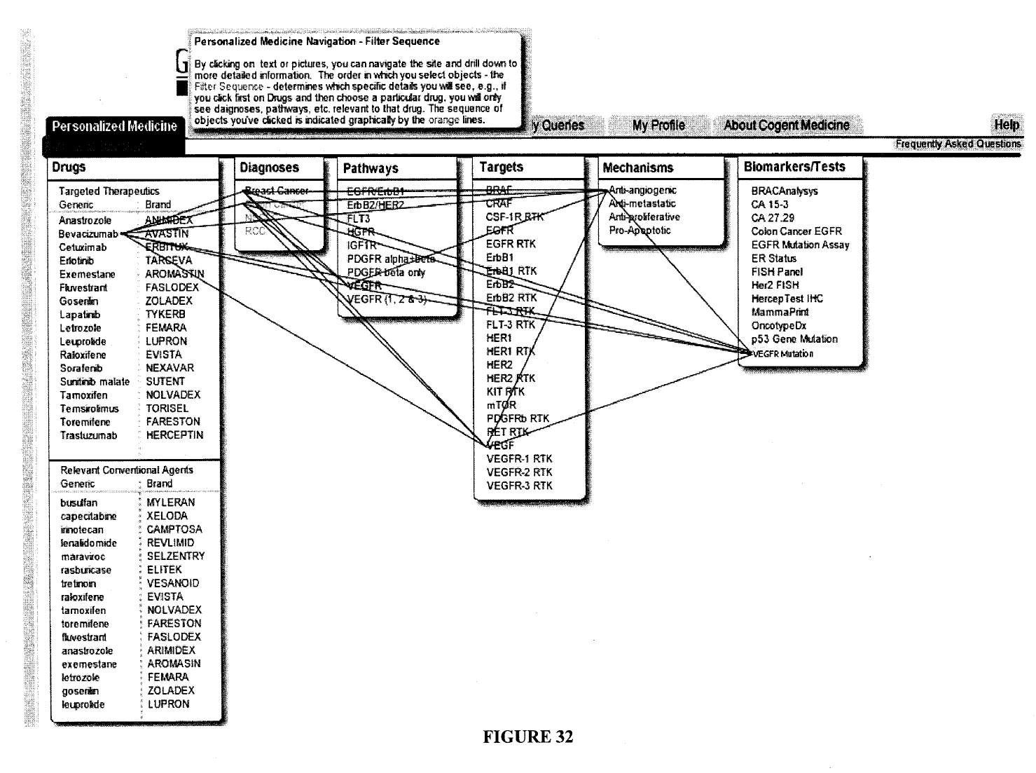

In the present invention, the items in an ontology can be further organized into a map e.g., a network map. Network maps are tools to organize information that minimally include a node and more generally include at least two nodes linked by an edge. In some embodiments, each node is connected to at least two, three, four, five, six, seven, eight, nine, ten, eleven, twelve, thirteen, fourteen, fifteen, twenty, or thirty other nodes by edges. Nodes usually represent concepts, in this case, items. Edges generally represent relationships between the subjects of two nodes. In this example, the relationship generally represents a biological relationship. FIG. 32 presents an example of a portion of a map of this invention. In this example, each node is an item of the ontology. Each node (item) is connected to at least one, and generally a plurality of other nodes (items) by edges. Each edge indicates that the two nodes are related in some defined way. So, for example, each item in the first level class of “Drugs” is connected by an edge to an item in the first level class “Diagnoses” based on the relationship that the drug is used to treat the disease. More specifically, FIG. 32 shows the item “Bevacizumab” connected to items “Breast Cancer” and “Colon Cancer” because that drug is used to treat those diseases. “Bevacizumab” is further linked to “VEGFR” in the “Pathways” class based on the relationship that the drug acts at some point in the VEGFR signal transduction pathway. The drug “Bevacizumab” is connected to the “Mechanism” item “Anti-angiogenic” based on the relationship that anti-angiogenesis is the mechanism of action of the drug. In the same way, “Pathway” item “ErB2/HER2” would be linked to “Diagnosis” item “Breast Cancer” based on the relationship that some breast cancers involve abnormal quantities and/or activities of members of this pathway. Again Bevacizumab, anti-angiogenic, VEGFR, Breast and Colon cancer are connected to VEGFR Mutation Test. Thus, the map of this invention can be considered as a web of connections between related items among the different first level classes.

Implicit in the structure of this map is the idea that every “node” is at the center or hub of a group of edges or spokes that connect to other nodes. This feature is useful as a means to navigate a website so that related information becomes readily available to the user. The user can jump from node to node to access related information. The ontology, the information included in the items, and the maps are organized and selected by experts in the domain subject field.

2.3 Content of the Information Structure

In some embodiments, the information structure comprises a database. In some embodiments, the database is a relational database management system. The information system contains information on subjects related to healthcare and biology. Healthcare information further comprises of information on dentistry, medicine, nursing, pharmacy, or physical therapy. Within the field of medicine, information on medicine includes pathophysiologies, diagnostic and/or prognostic tests, therapeutic modalities, treatment algorithms, and/or drug responsiveness. In certain embodiments, the areas are clinical medicine and, more specifically, personalized clinical medicine. Personalized medicine is a practice of medicine in which treatment options are selected at least in part based on the particulars of molecular biology that differ from person to person. For example, the over-expression of HER2, a particular genetic allele, can influence the selection of the particular treatment regimen for a woman with breast cancer.

2.3.1 Pathophysiology

Pathophysiology is the study of the etiology, development and elimination of the biological and physical manifestations of disease. Information on pathophysiologies includes information on prepathologic conditions, malignancies, autoimmune diseases, infectious diseases, inflammatory diseases, psychiatric disorders, or neurological diseases. Additionally, information on pathophysiologies further comprises information on conditions that predispose an individual to a pathophysiology, including the contribution of acquired or inherited genetic variance. Further information on pathophysiologies includes information on signal transduction pathways involved in the pathophysiologies.

Malignancies are a class of diseases in which cells display the traits of uncontrolled growth, invasion into adjacent tissues, and frequently distant or metastatic spreading throughout the body. These three properties differentiate tumors composed of malignant cells from benign tumors, which are self limited, do not invade or metastasize. The term “malignancies” also encompasses hematologic diseases that do not form solid tumors. Information on malignancies comprises information on malignant conditions and/or information on pre malignant conditions. A listing of malignant conditions encompassed by the present invention can be found in SNOMED Clinical Terms (SNOMED CT) or International Statistical Classification of Diseases and Related Health Problems (ICD 9) codes 140 239: Neoplasms.

Autoimmune diseases result from an overactive immune response of the body against substances and tissues normally present in the body. A listing of autoimmune diseases encompassed by the present invention can be found in ICD 9 codes 240 279: Endocrine, nutritional and metabolic diseases, and immunity disorders.

Infectious diseases are a class of diseases that result from the presence of pathogenic microbial agents, including viruses, bacteria, fungi, protozoa, multicellular parasites, and aberrant proteins known as prions. A listing of autoimmune diseases encompassed by the present invention can be found in ICD 9 codes 001 139, infectious and parasitic diseases. Further information on specific infectious and parasitic diseases can be found in ICD 10, chapters A and B.

Inflammatory diseases encompass diseases that have a major inflammatory component and include rheumatoid arthritis, osteoarthritis, inflammatory lung disease, inflammatory bowel disease, atherosclerosis and psoriasis. Since inflammation is also a response of the immune system, there can be an overlap in diseases that comprise autoimmune and inflammatory diseases.

A listing of psychiatric diseases encompassed by the present invention can be found in ICD 9 codes 290 319: Mental disorders. An alternative listing of psychiatric disorders encompassed by the present invention can be found in the American Psychiatric Association's (APA) Diagnostic and Statistical Manual of Mental Disorders (DSM).

2.3.2 Diagnostic and Prognostic Tests

Information on diagnostic and/or prognostic tests comprises the assessment of biomarkers, standard laboratory tests, medical imaging, and/or physical examination.

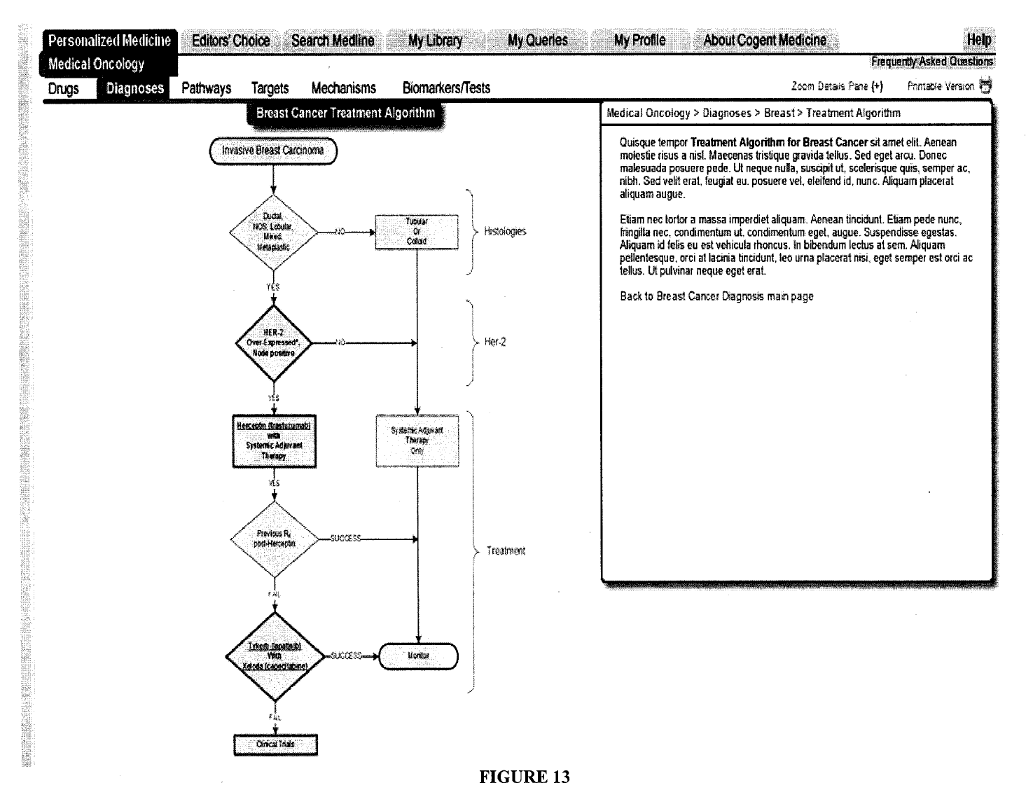

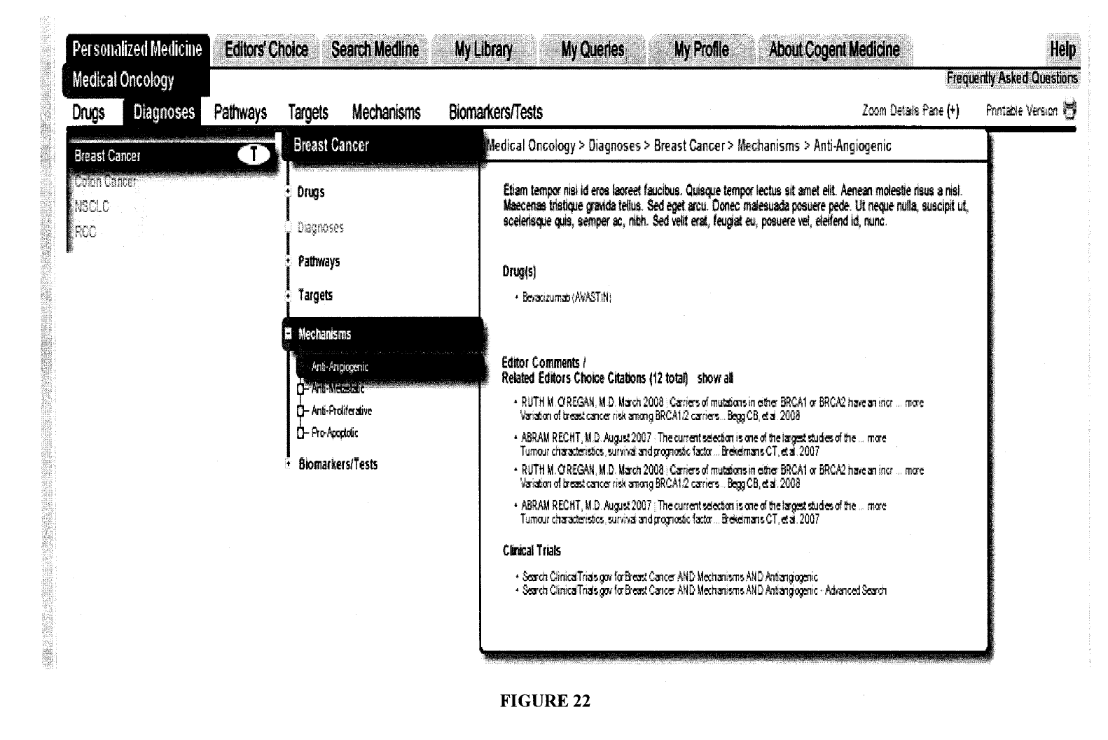

Biomarkers are substances produced by an organism that can be objectively detected and quantified. The presence and/or quantity of a biomarker can be used to classify disease or indicate the biologic state of the organism, including a disease state. For example, if the biomarker is an antibody to hepatitis B virus, the presence of the antibody in a patient's plasma may reflect active disease, a previous infection or successful vaccination. Similarly, prostate specific antigen (PSA) is a naturally occurring substance produced by men with an intact prostate. In healthy men under 60 years of age, the normal range of blood PSA levels is 3 ng/ml or less. A value above 3 ng/ml, but less than 10 ng/ml is usually due to a benign enlarged prostate. Higher values are frequently indicative of prostate cancer, but confirmatory tests are required. The PSA levels of prostate cancer patients usually fall in response to successful treatment allowing for monitoring of prostate cancer recurrence through periodic analysis of the post treatment PSA levels. In such a manner, biomarkers can be used to assess risk of disease, diagnose or prognose a health condition, and evaluate a patient's response to a drug or other type of therapeutic intervention. Her-2 is a further example of a biomarker, one that can be used a “personalized medicine” biomarker, FIGS. 13 and 22. Over-expression of Her-2 in breast cancer patients, as exemplified by a finding of >3 by immunohistochemistry or >2.1 by fluorescent in situ hybridization (FISH), indicates disease that is generally more aggressive than other forms of breast cancer and also less responsive to hormonal treatment. Patients with breast cancer that over-expresses Her-2 can be prescribed Herceptin, a monoclonal antibody that blocks ligand binding to the EGF receptor and thereby reduce mitogenic signaling

Standard laboratory tests include microbiology, parasitology, virology, hematology, clinical biochemistry, toxicology, immunology, histopathology, cytopathology, pathology, and genetics.

Medical imaging includes x rays, computerized tomography, positron emission tomography, single photon emission computed tomography, fluoroscopy, magnetic resonance imaging, and ultrasound modalities.

2.3.3 Therapeutic Modalities

The information on therapeutic modalities further comprises information on drugs, radiotherapy, surgery, transplantation, genetic therapy, regenerative medicine, psychiatric and other counseling, and/or physical therapy.

The information presented on therapeutic modalities includes mechanisms of action, effectiveness, applicability, known side effects, availability including whether the therapeutic modality is approved for a particular indication, and cost. The information on drugs further comprises information on small molecules, biologics, natural products, derivatives and combinations thereof.

Information on radiotherapy includes information on external beam radiotherapy, brachytherapy, and the local or systemic administration of radioactive substances including elements, nucleotides, drugs, radiolabeled peptides or radiolabeled antibodies.

Information on surgery includes information of surgical procedures used for specific diseases, health conditions, organ systems, or tissues, e.g., coronary artery bypass surgery to relieve angina. Additionally, information is provided on diagnostic surgical procedures like biopsies. Further surgical information includes information on outpatient procedures, elective surgery, emergency surgery, keyhole or laparoscopic surgery, microsurgery.

Information on transplantation includes information on the transplantation of whole or partial organs, tissues or stem cells. Organs, tissues, and stem cells can be of allogenic or autologous origin.

Information on genetic therapy includes information on somatic cell gene therapy. Additionally, information is provide on methods of somatic cell gene therapy such as the use of retroviruses, adenoviruses, adeno-associated viruses, naked DNA, and liposomal DNA complexes.

Information on regenerative medicine includes fetal, umbilical cord blood, and adult stem cell therapy. Stem cells include totipotent, pluripotent, multipotent and unipotent progenitor cells. Additionally, information on regenerative medicine includes information on the use of biologics and small molecules that can coax, stimulate, and/or direct the proliferation and/or migration of stem cells.

Information on psychiatric and other counseling includes information on depression, anxiety, PTSD, OCD, psychosis, dementia, delirium, substance abuse and Addiction, impulse control disorders, ADD, ADHD, personality disorders, pharmacotherapy, psychotherapy, behavioral therapy, detoxification, and combinations thereof.

Information on physical therapy includes information on orthopedic, geriatric, neurological, cardiovascular and pulmonary rehabilitation, and pediatric physical therapy.

2.3.4 Diagnostic and Treatment Algorithms

Conventional diagnostic and treatment algorithms standardize decision making in the attempt to improving technical quality of care. Through a decision tree composed of a series of questions, a health care practitioner is guided to the “correct” diagnosis and treatment for the most commonly observed pathologies.

Unlike conventional diagnostic and treatment algorithms, the algorithms of the present invention do not represent general or standard knowledge and therefore they do not dictate to the healthcare practitioner the “correct” diagnostic test or treatment. Instead experts present data, analysis and recommendations to be considered by the health care practitioner in the implementation of a diagnostic and/or treatment scheme. This approach is particularly important in areas such as targeted therapeutics where the number of agents in clinical development is growing rapidly. For instance, there are approximately 12 signal transduction inhibitors for the treatment of cancer, but over 400 signal transduction inhibitors are in various stages of development including clinical trials.

As an example of how the information system of the present invention can assist a healthcare practitioner, consider a healthcare practitioner with a cancer patient that has experienced a recurrence after conventional therapy. By providing a treatment algorithm that incorporates knowledge of the specific signal transduction pathways that are implicated in the growth and progression of the particular cancer, the healthcare practitioner can consider the off label use of an approved drug to treat the patient's disease. Using imatinib (Gleevac®) as a specific example, imatinib binds to and inhibits the activity of tyrosine kinase domains of bcr-abl, c-kit and platelet-derived growth factor receptor (pdgf-r). Imatinib is approved for the treatment of chronic myelogenous leukemia (bcr-abl) and gastrointestinal stromal tumors (c-kit), but other forms of cancer also rely on tyrosine kinase activity for growth and progression including malignant gliomas, meningioma, head and neck carcinoma, prostate carcinoma and ovarian carcinoma. By offering a recommendation to consider testing for the presence of tyrosine kinase mutations that are inhibited by imatinib and that may also be involved with the patient's specific form of cancer, the healthcare practitioner is presented with information that can guide the practitioner to consider the off label treatment of the patient with imatinib if test results warrant.

Alternatively, the treatment algorithm may present or recommend the use of drugs that are currently undergoing clinical trials. In this case, the healthcare practitioner could see if the patient qualifies for enrollment in a clinical trial or the practitioner may elect to explore the treatment of the patient under a compassionate plea arrangement with the FDA.

2.3.5 Drug Responsiveness

Information on drug responsiveness comprises information on genetic (genotypic) and physiologic (phenotypic) variations that influence the absorption, distribution, metabolism or elimination and ultimately the effectiveness and toxicity of administered drugs. The field of study of genetic variations involved with drug responsiveness is known as pharmacogenetics and encompasses the study of single nucleotide polymorphisms (SNPs) and haplotypes. Physiologic variations include gender, body mass index, and level of physical fitness.

2.3.6 Biology

The information on subjects related to biology comprises information on normal and abnormal cells, tissues, organs, organ systems, immunologic and cognitive/behavioral functions. Information may comprise information from specific scientific disciplines such as immunology, cell and molecular biology, botany, zoology, microbiology, biochemistry, physiology, ecology, neurobiology, and evolutionary biology, or information gained from across disciplines in any combination of fields.

2.4 Expert Commentary and Expert-Curated Information

Selection, by a user, of a graphical element displayed within a graphical representation produces expert commentary on the item, and expert-curated information relating the item to the subject.

2.4.1 Expert Commentary

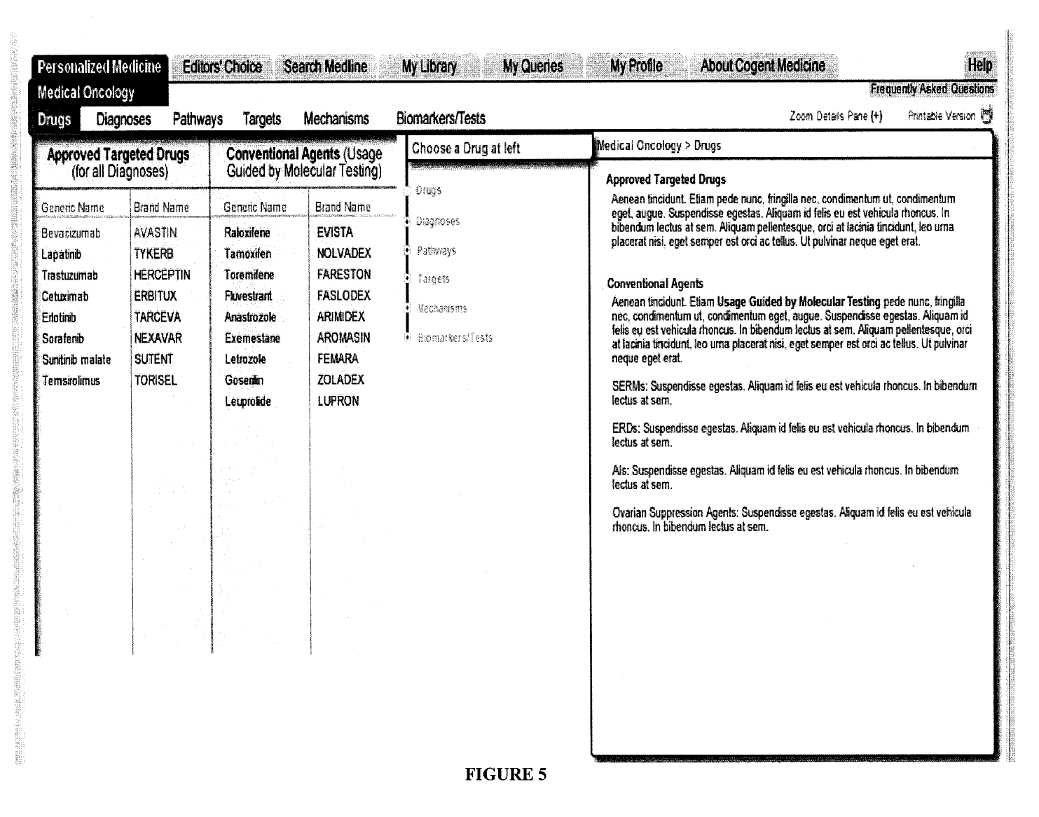

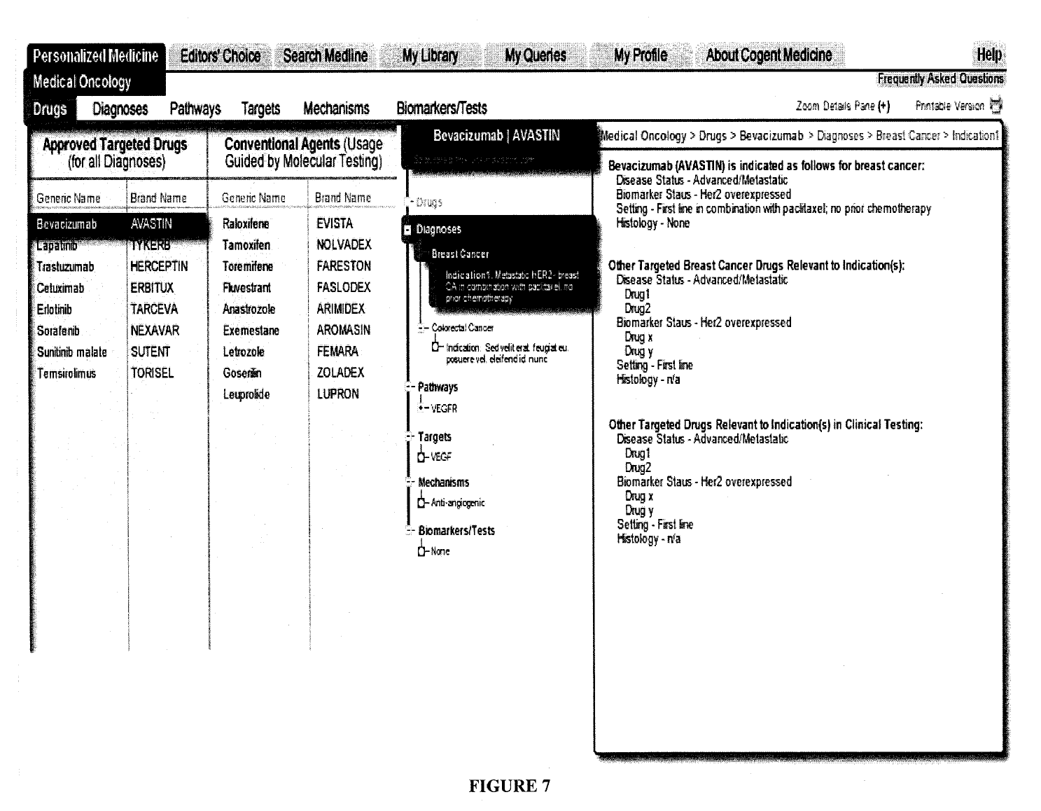

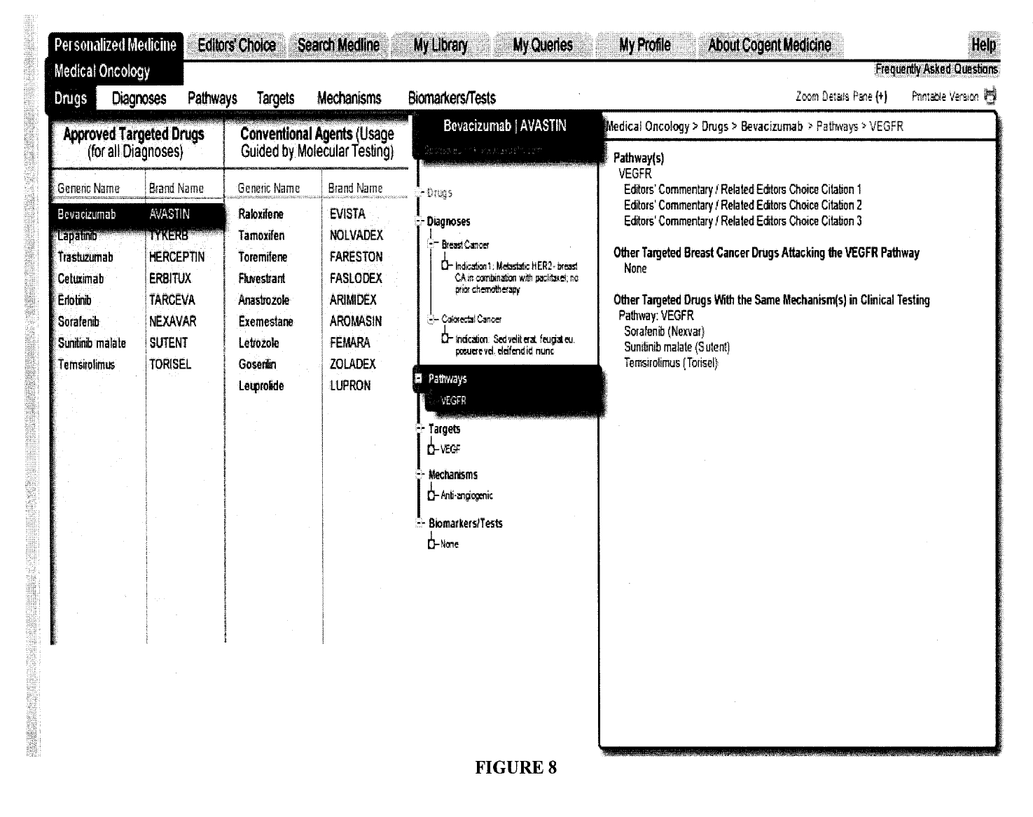

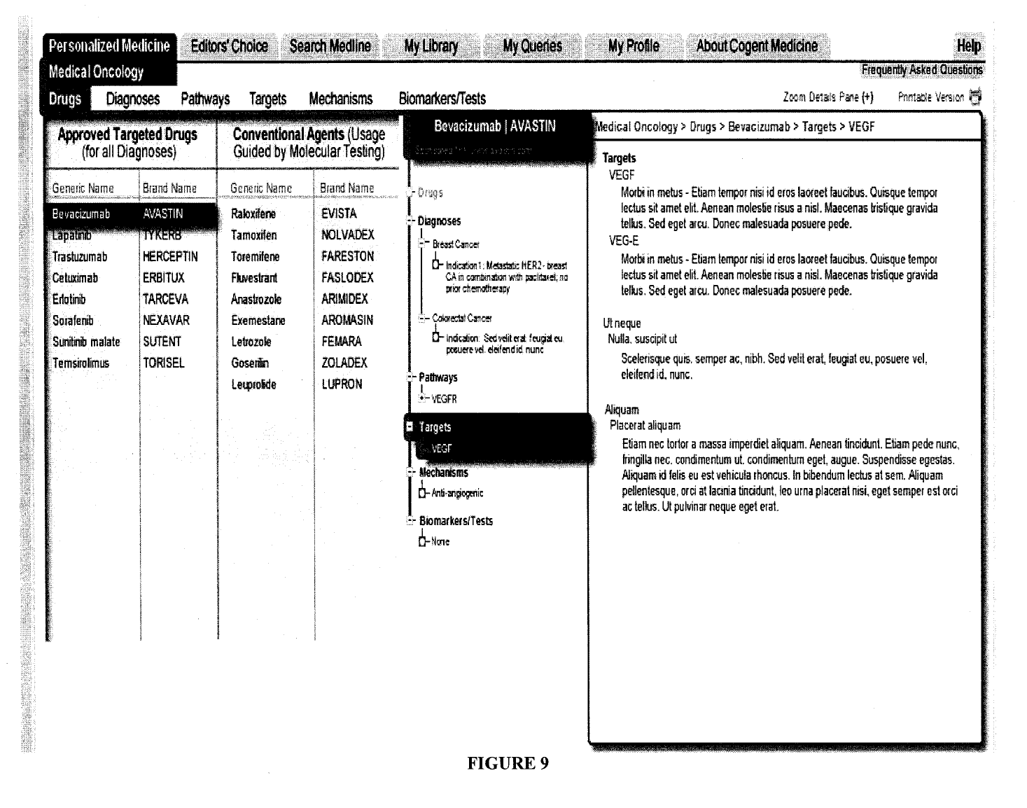

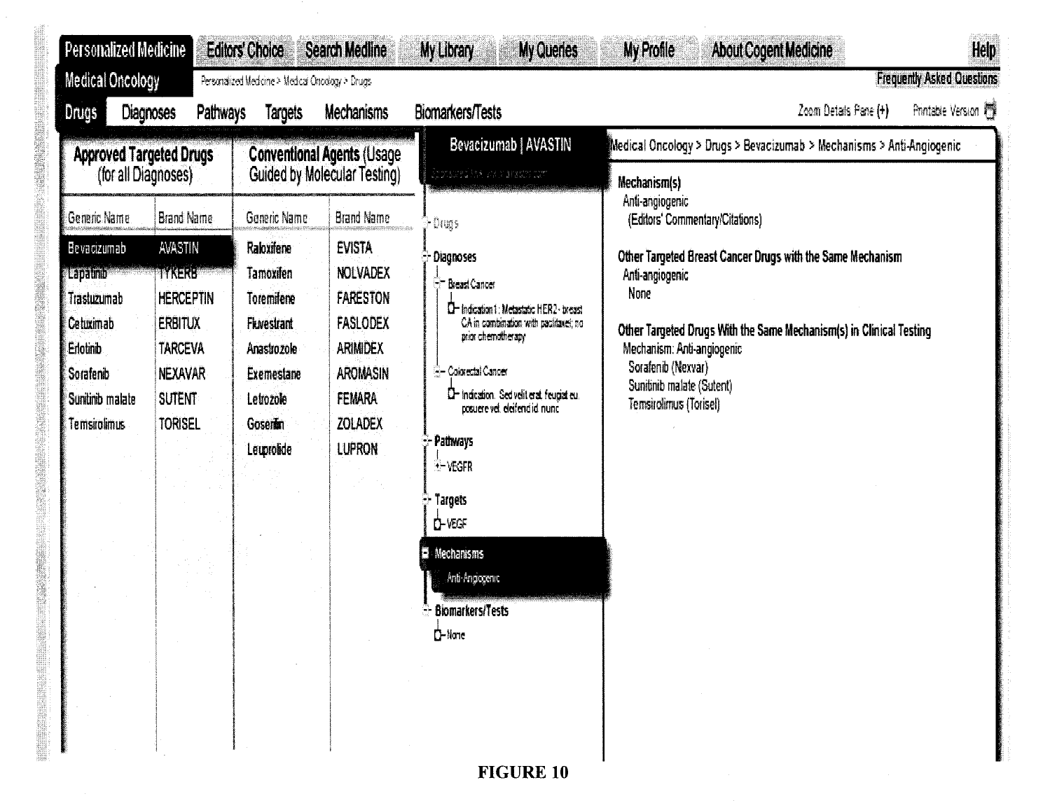

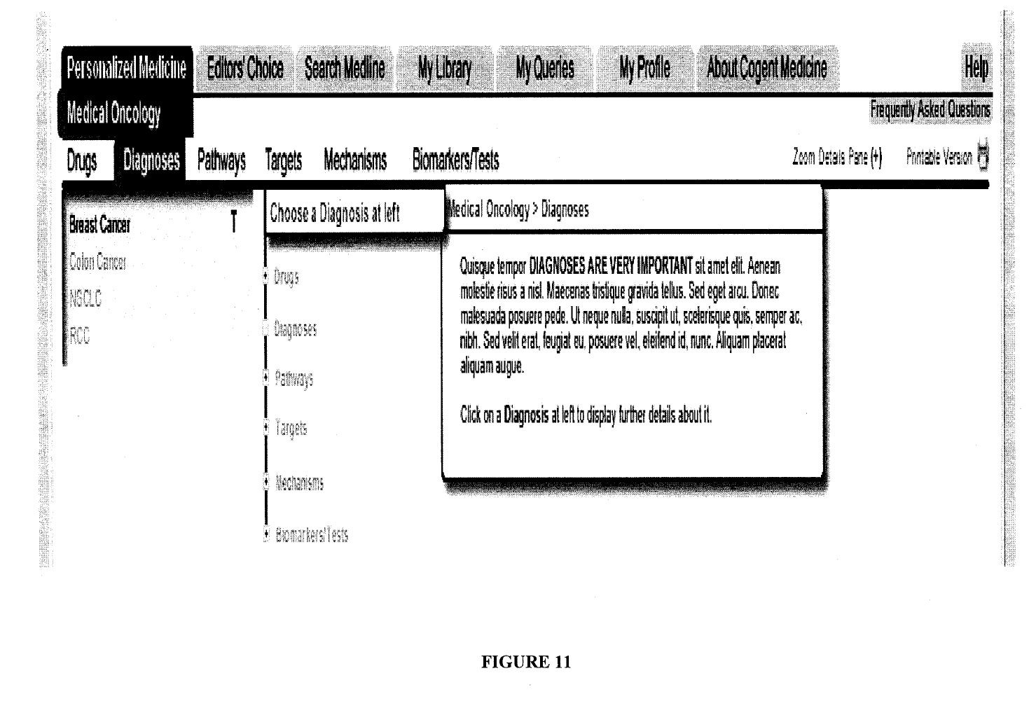

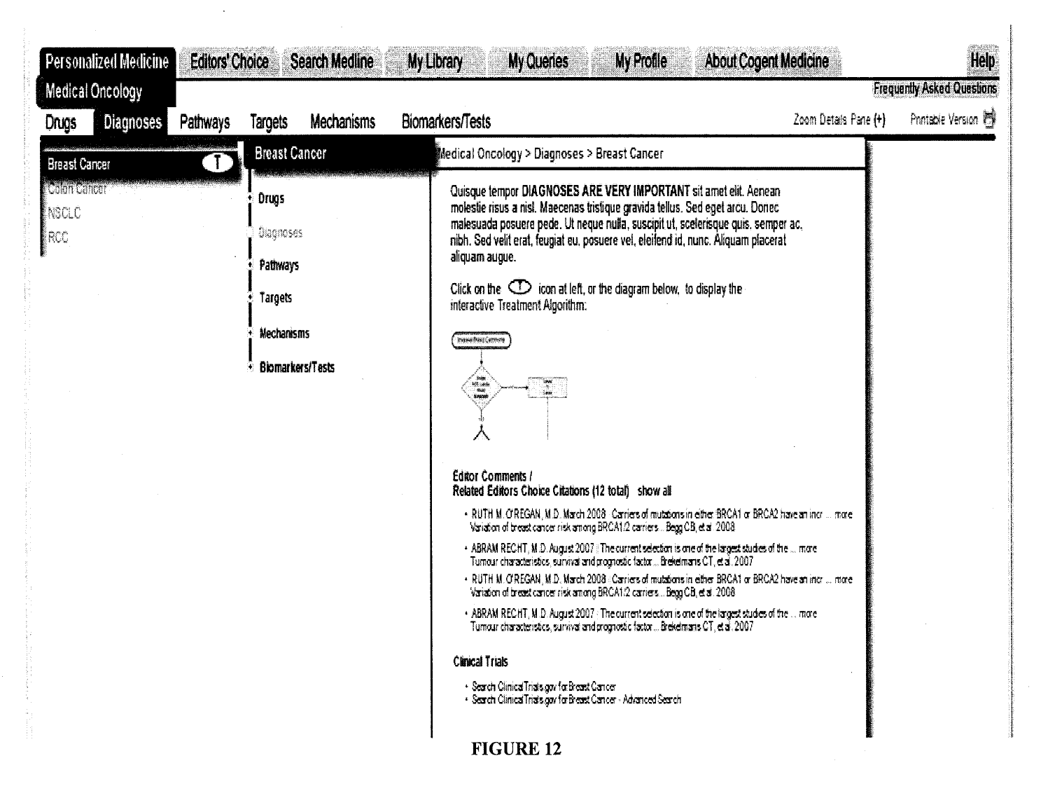

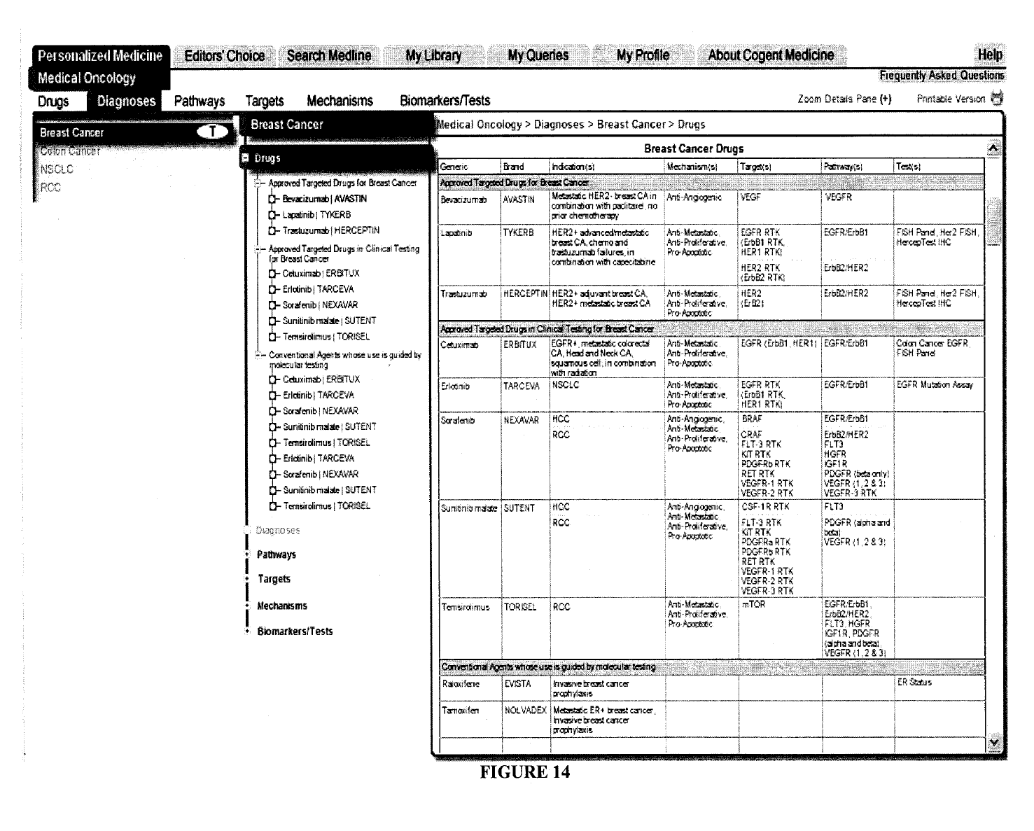

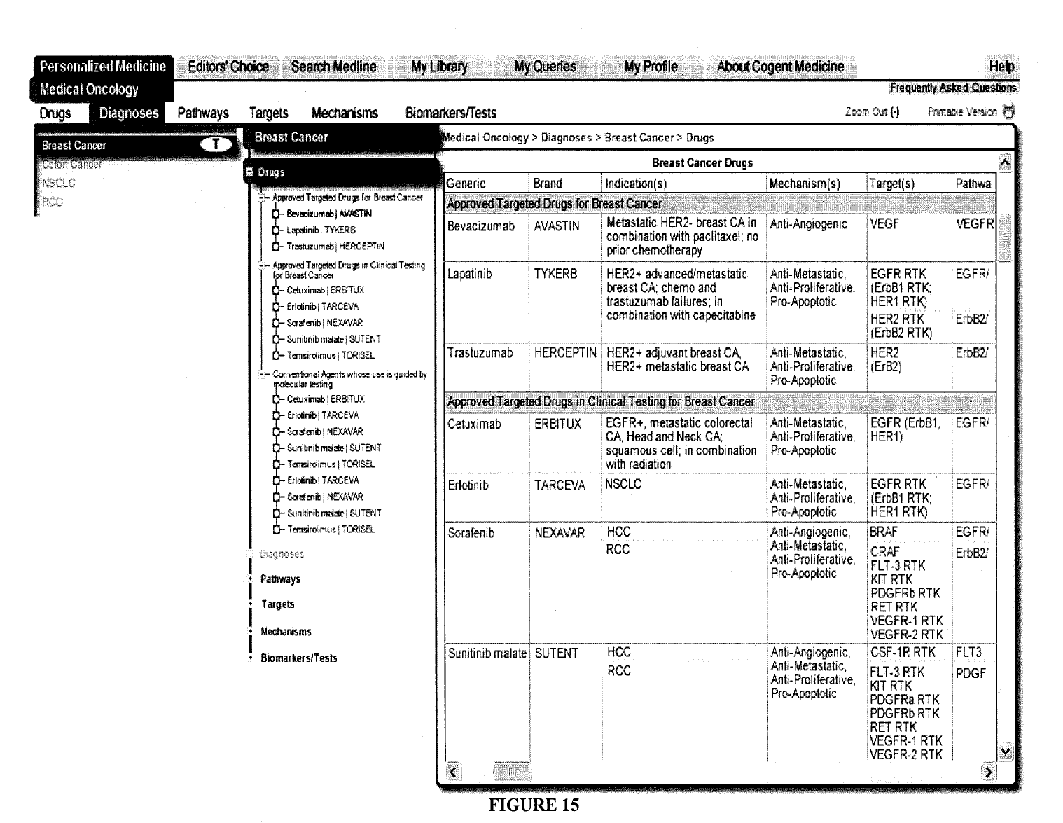

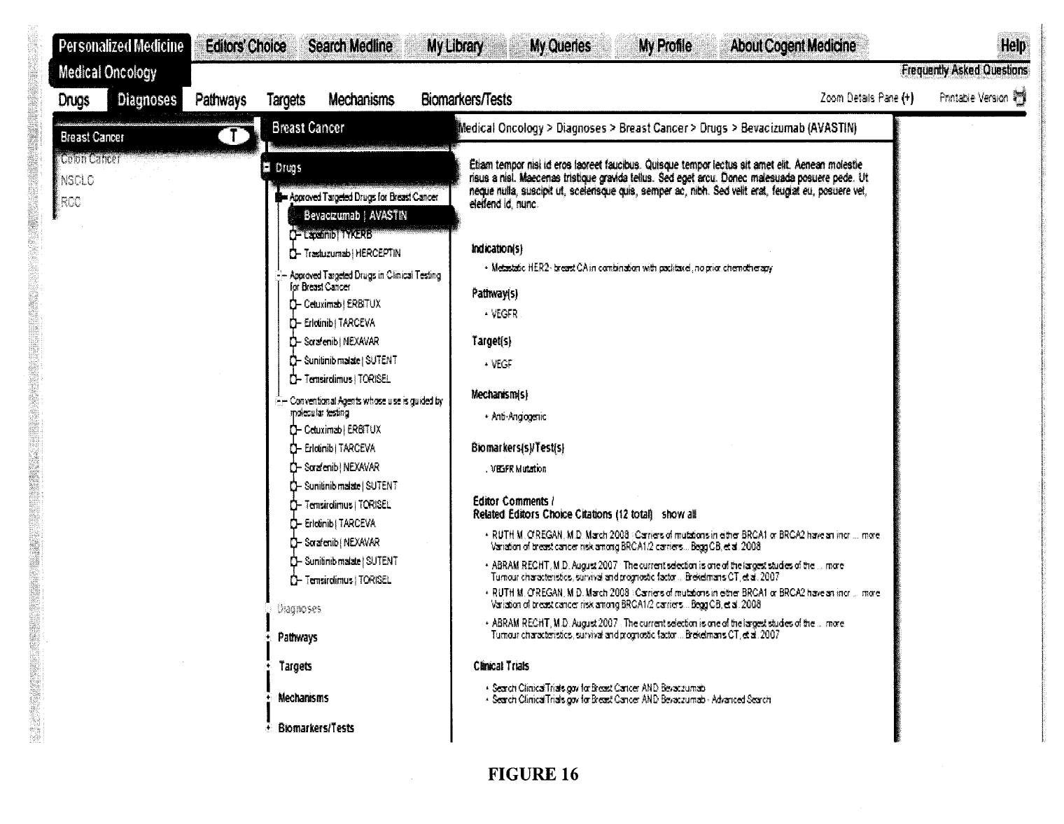

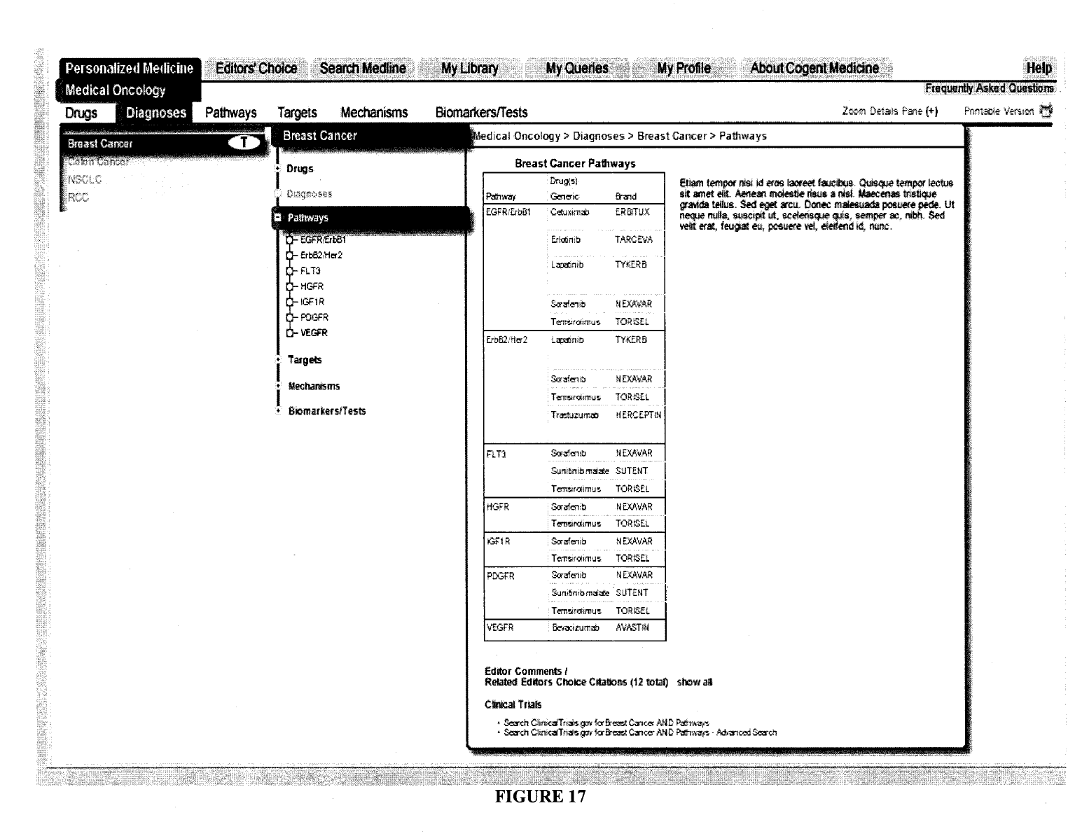

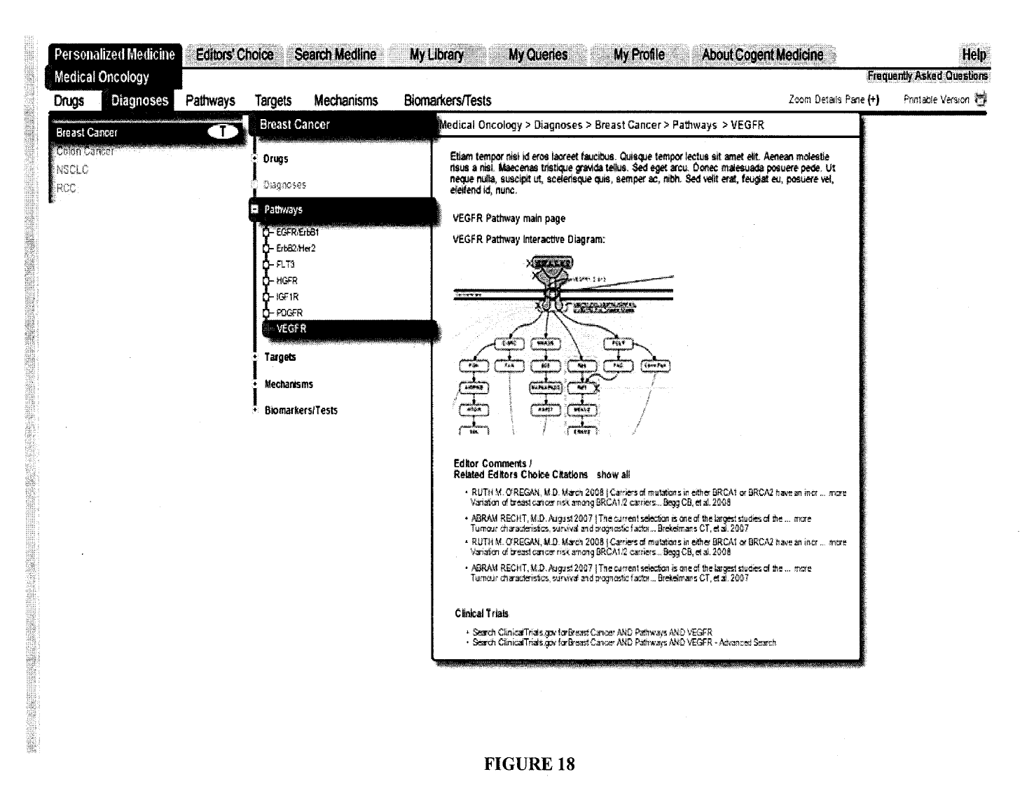

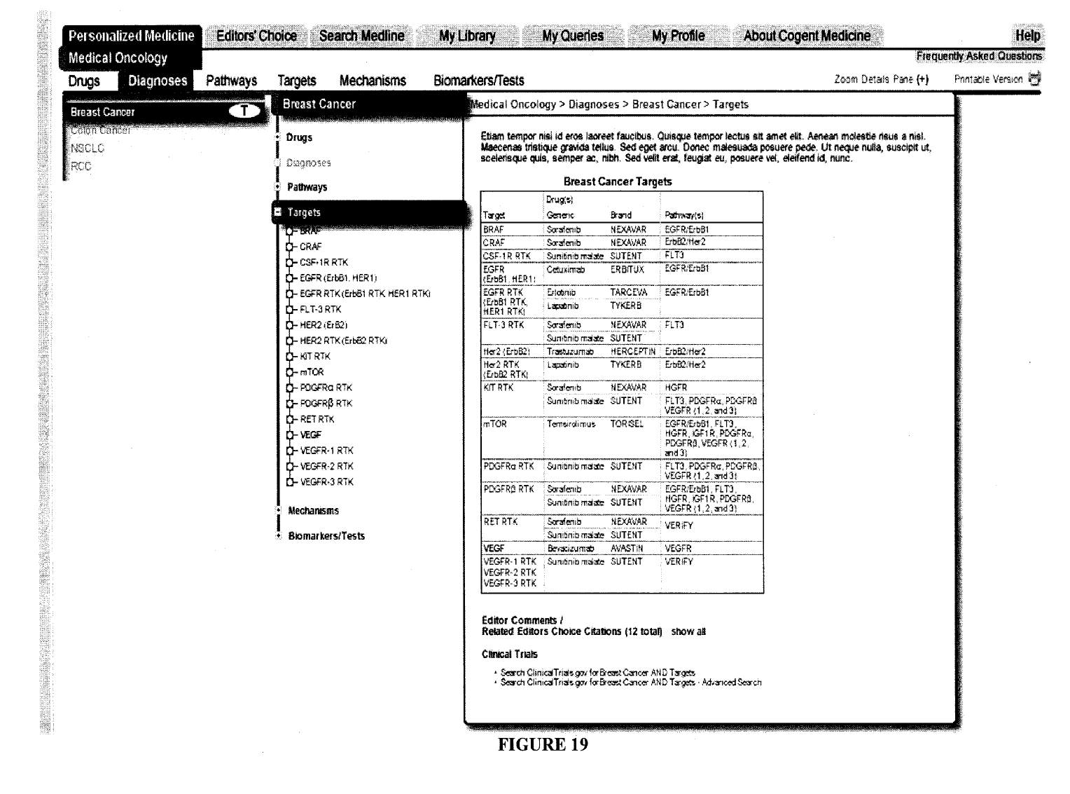

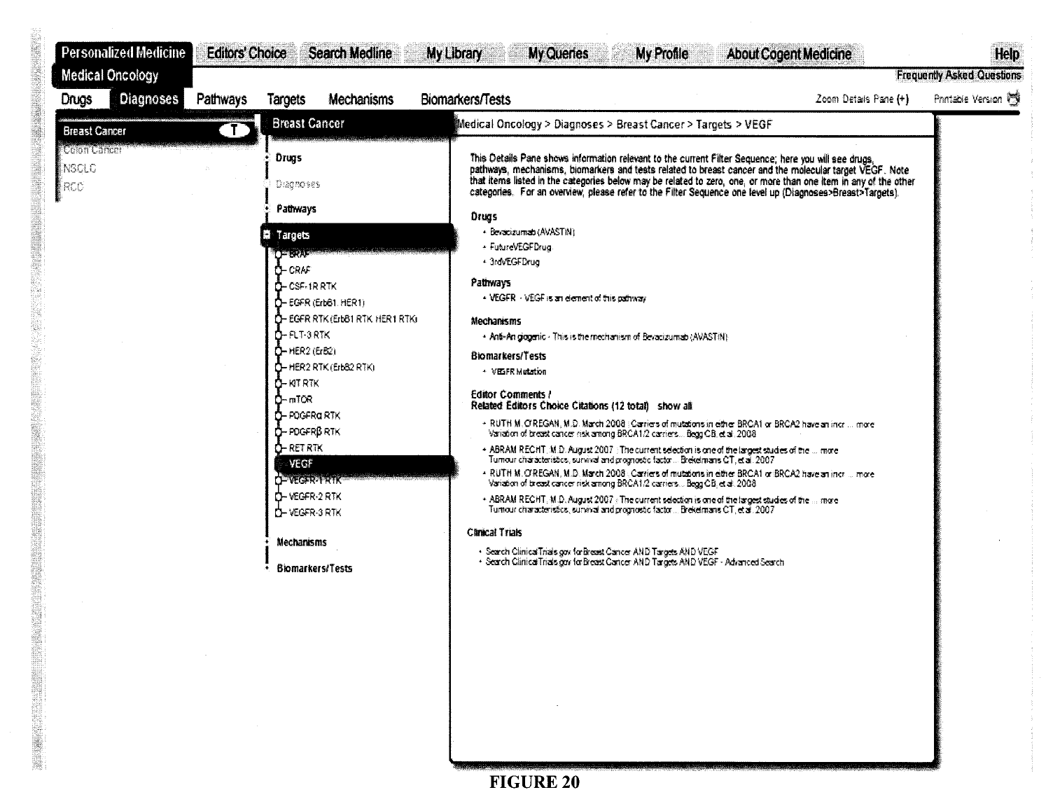

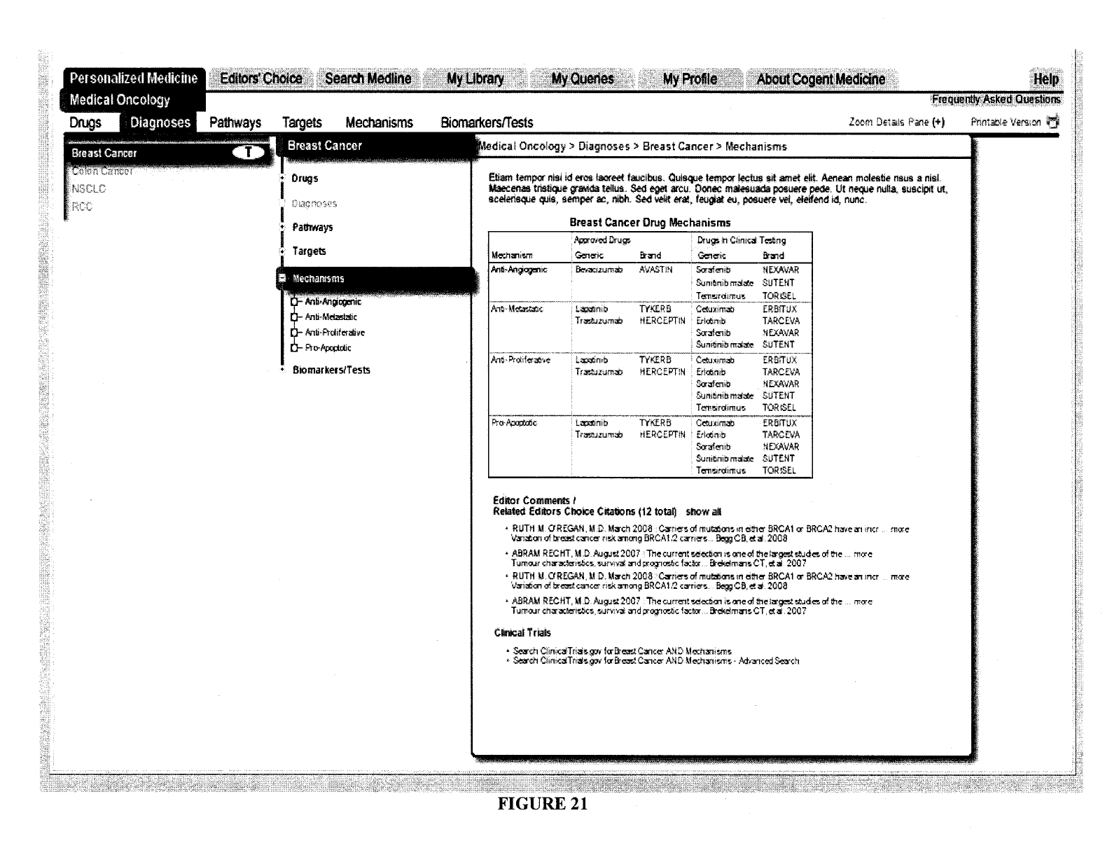

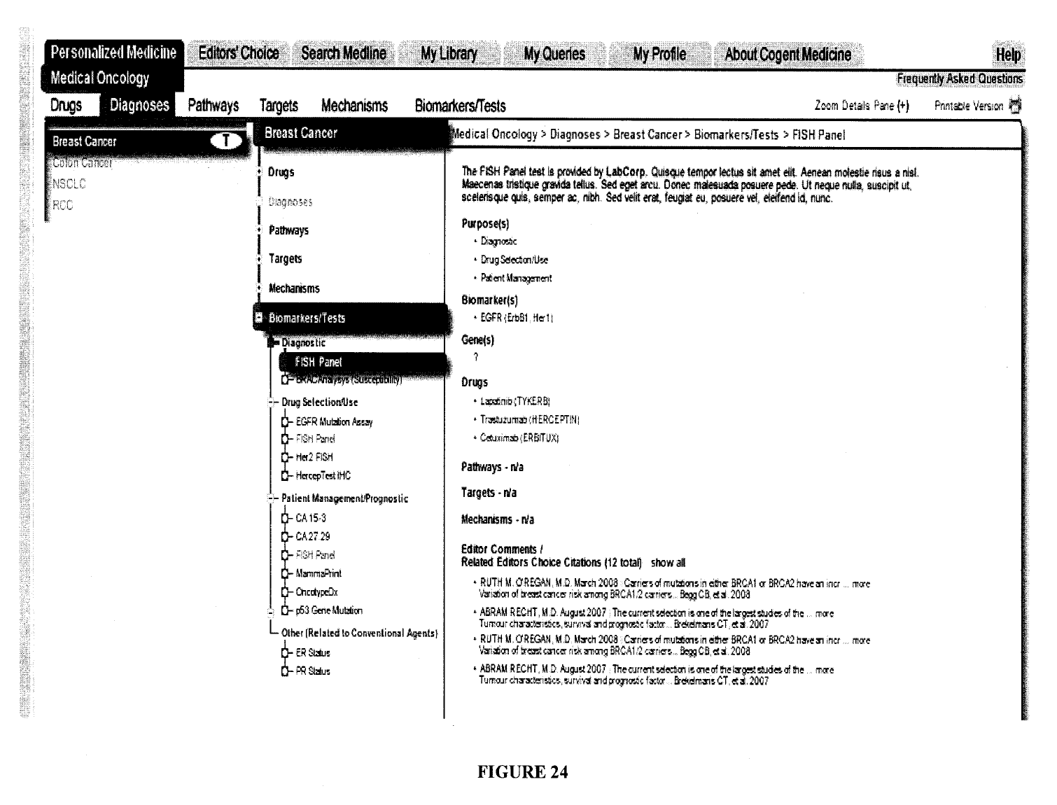

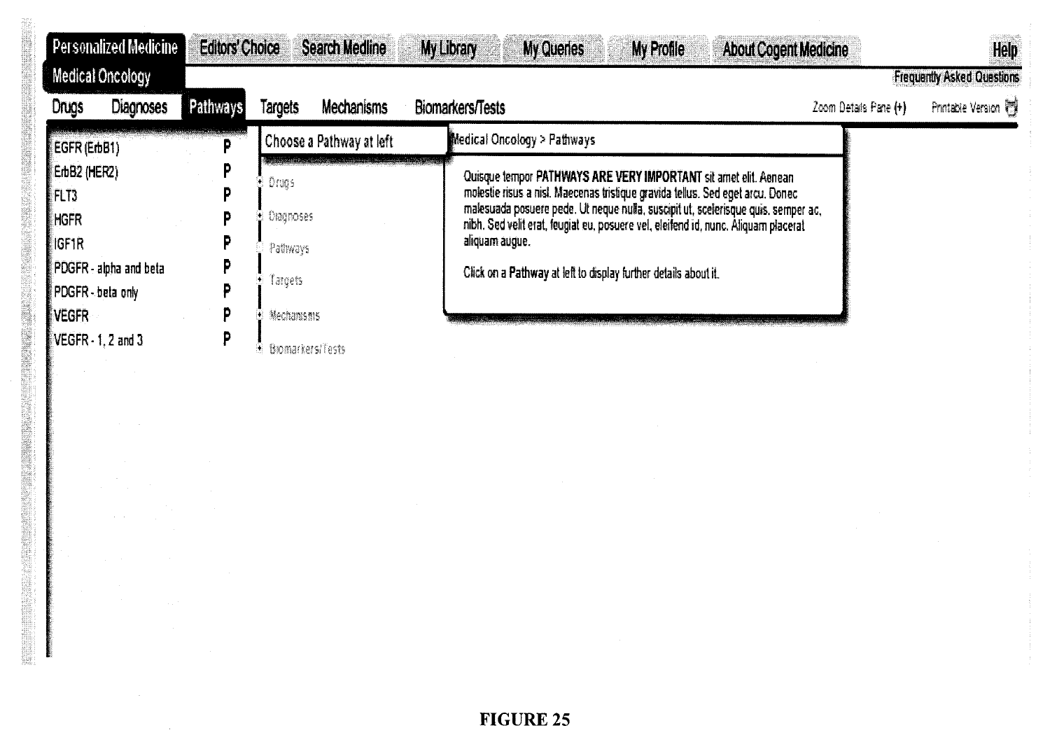

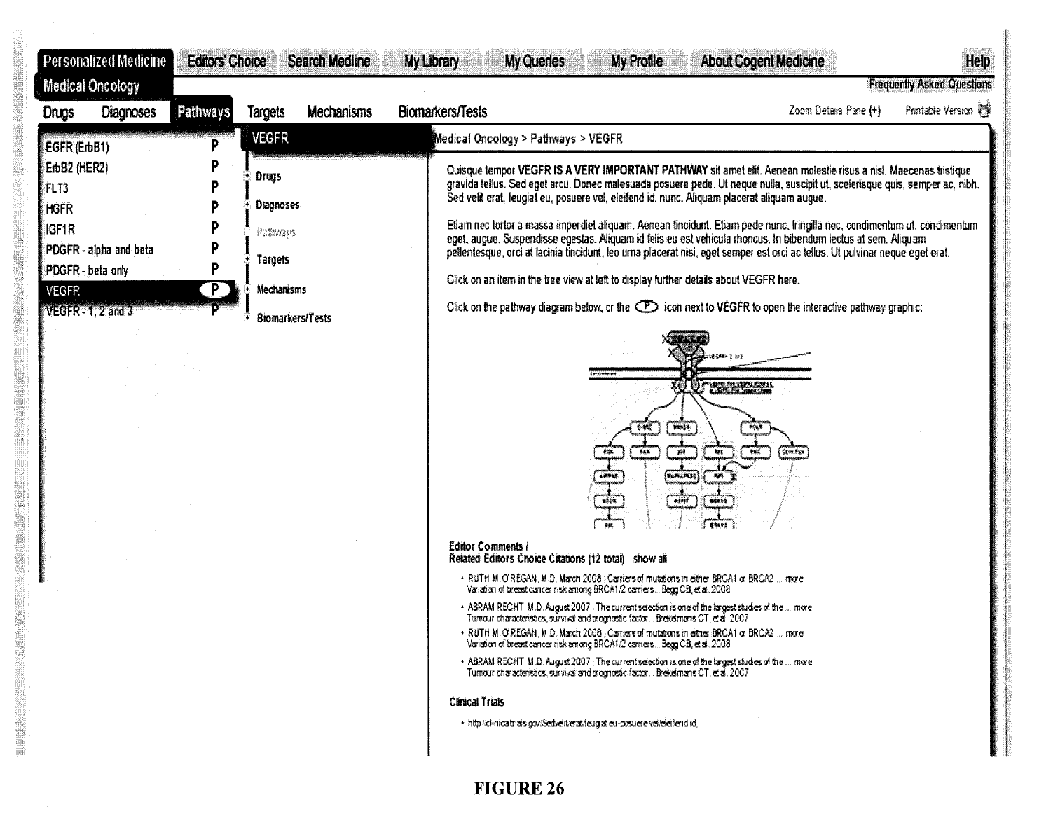

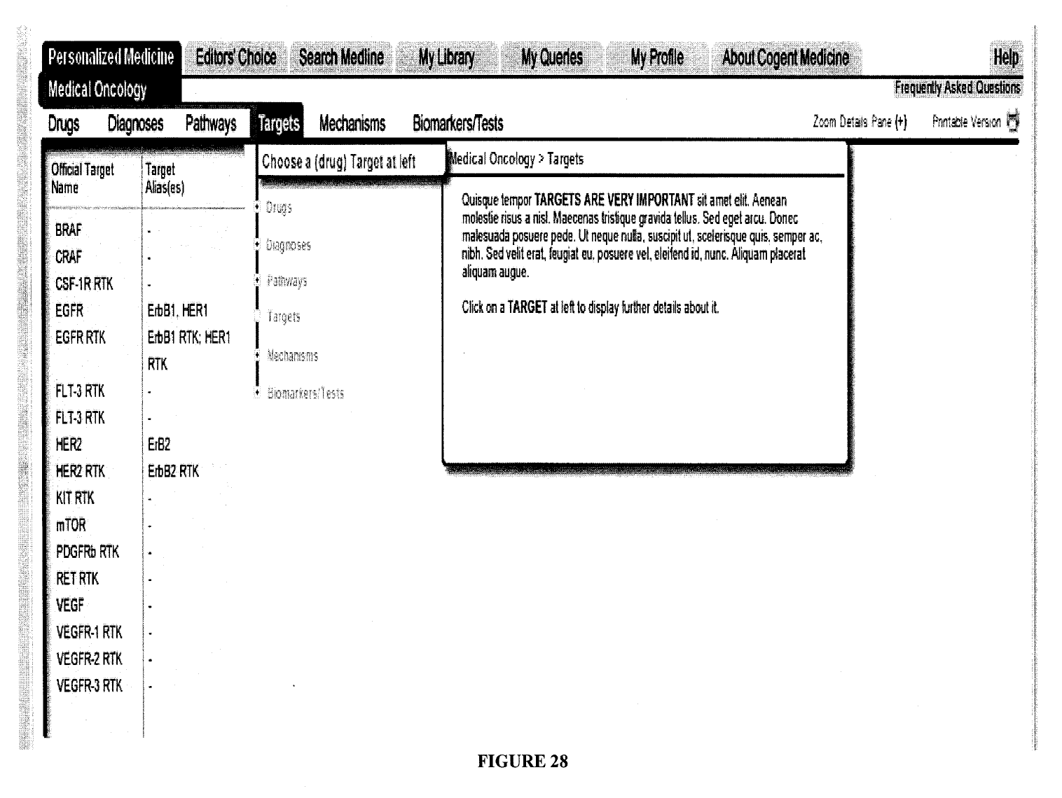

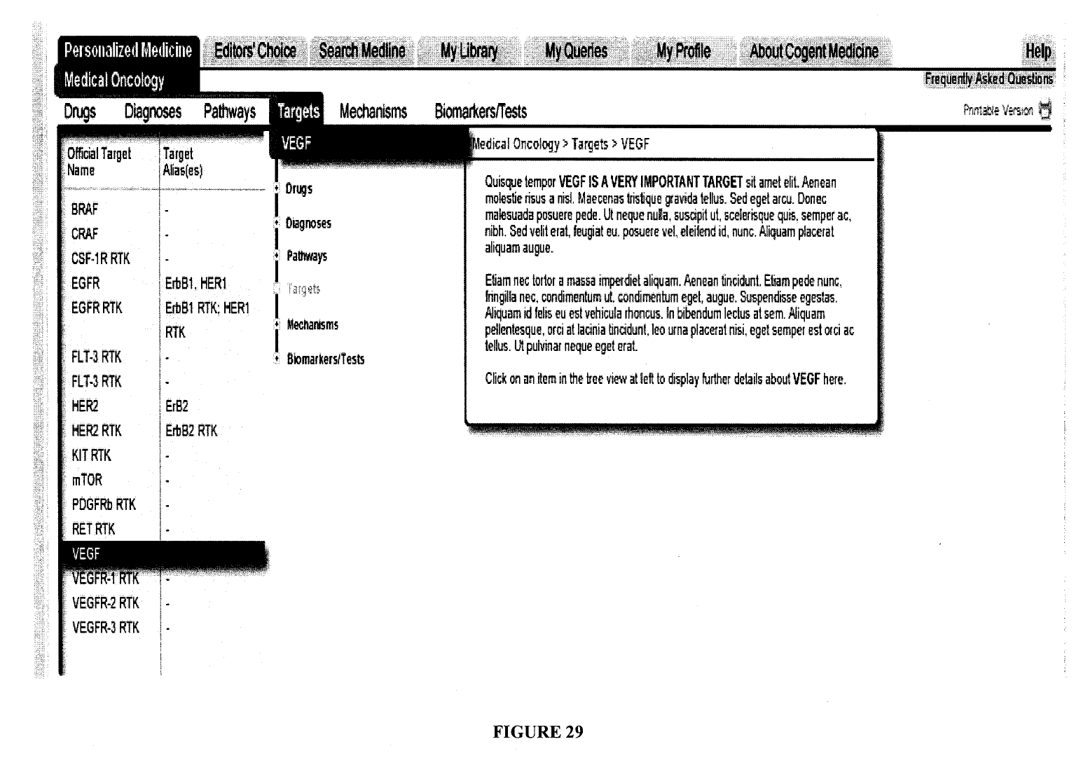

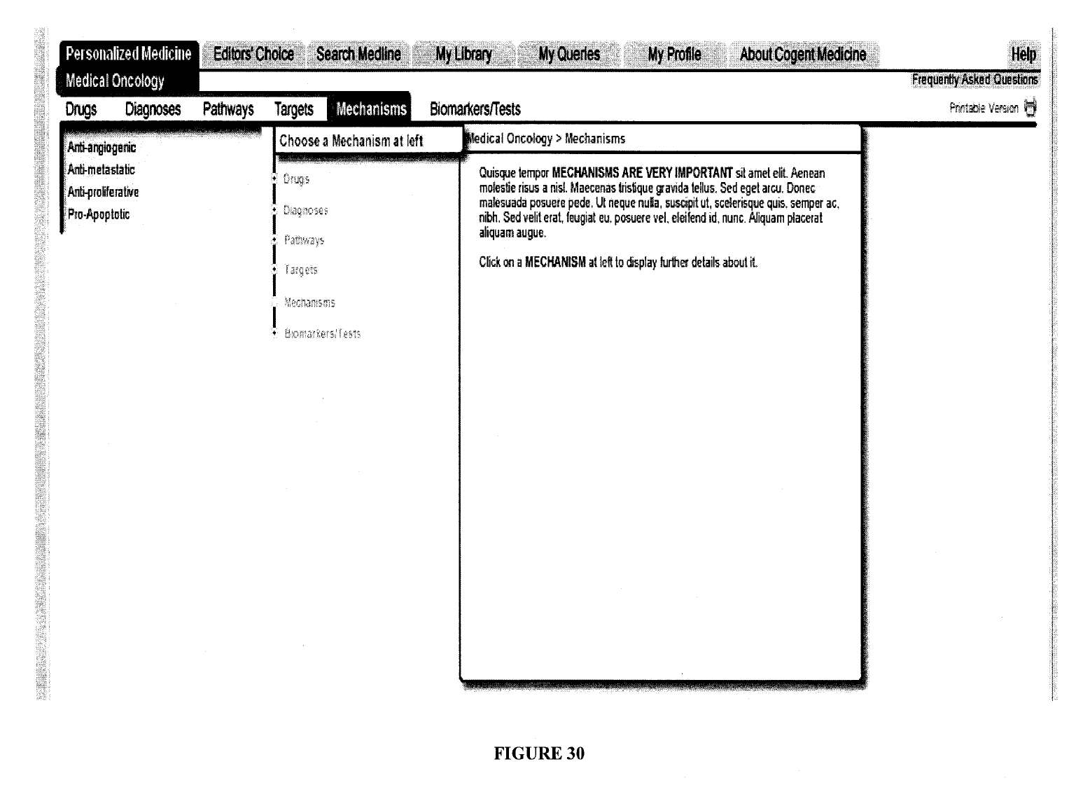

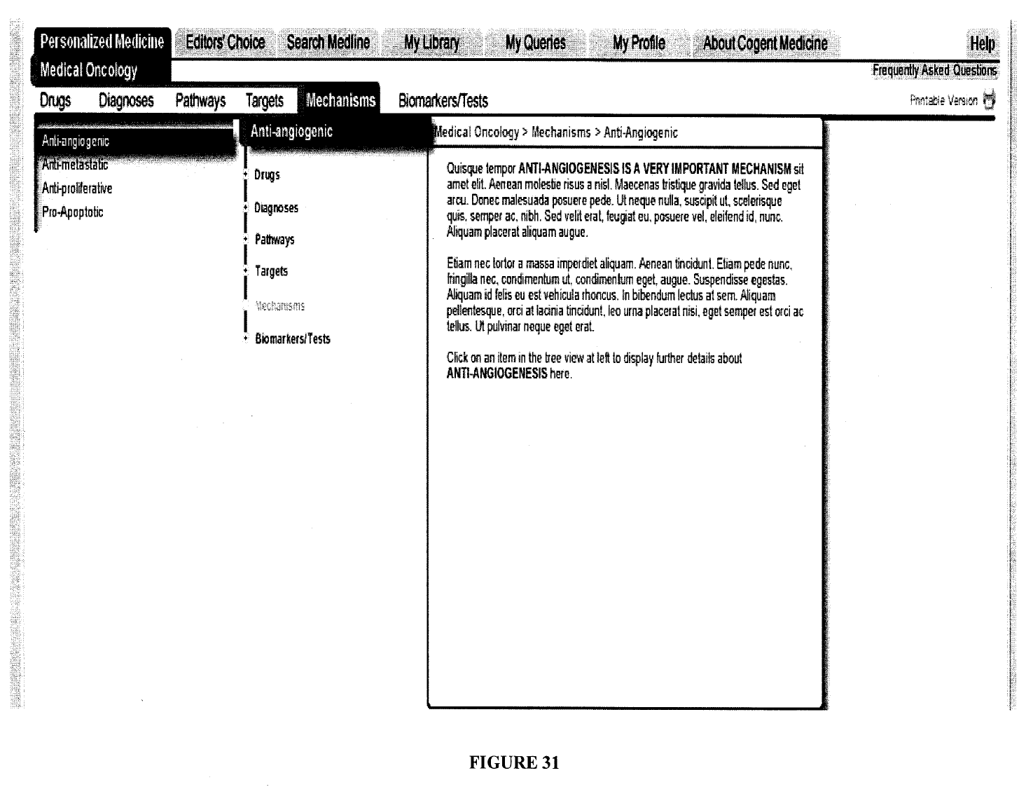

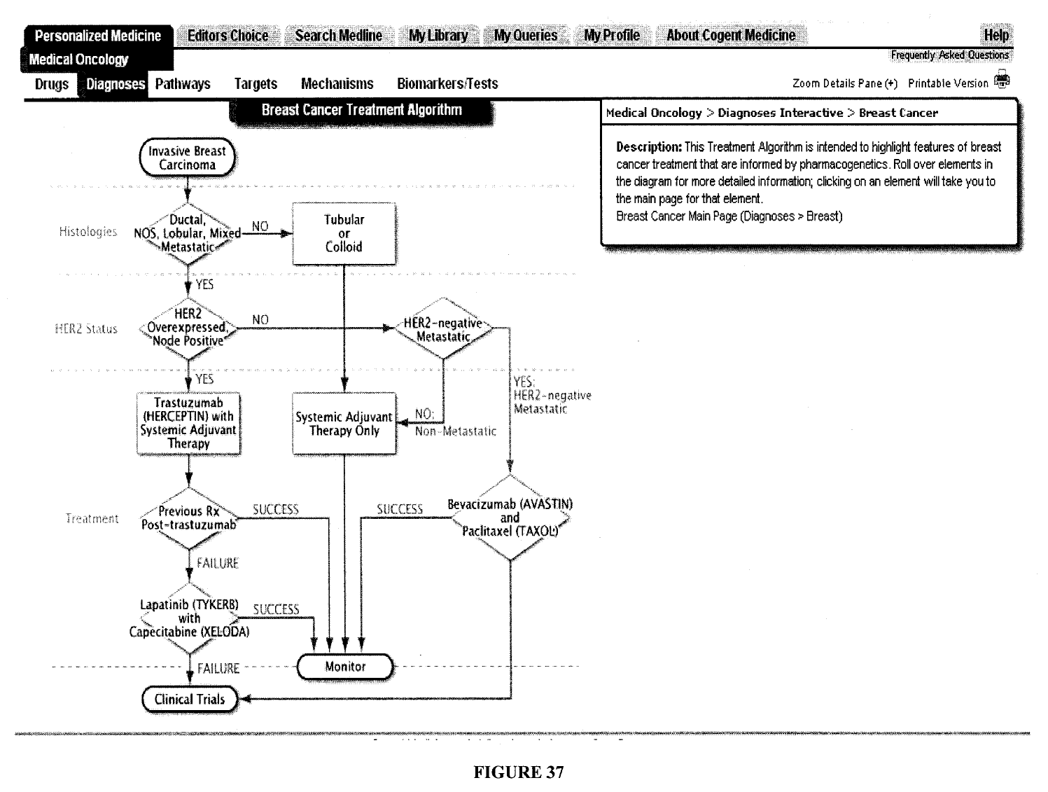

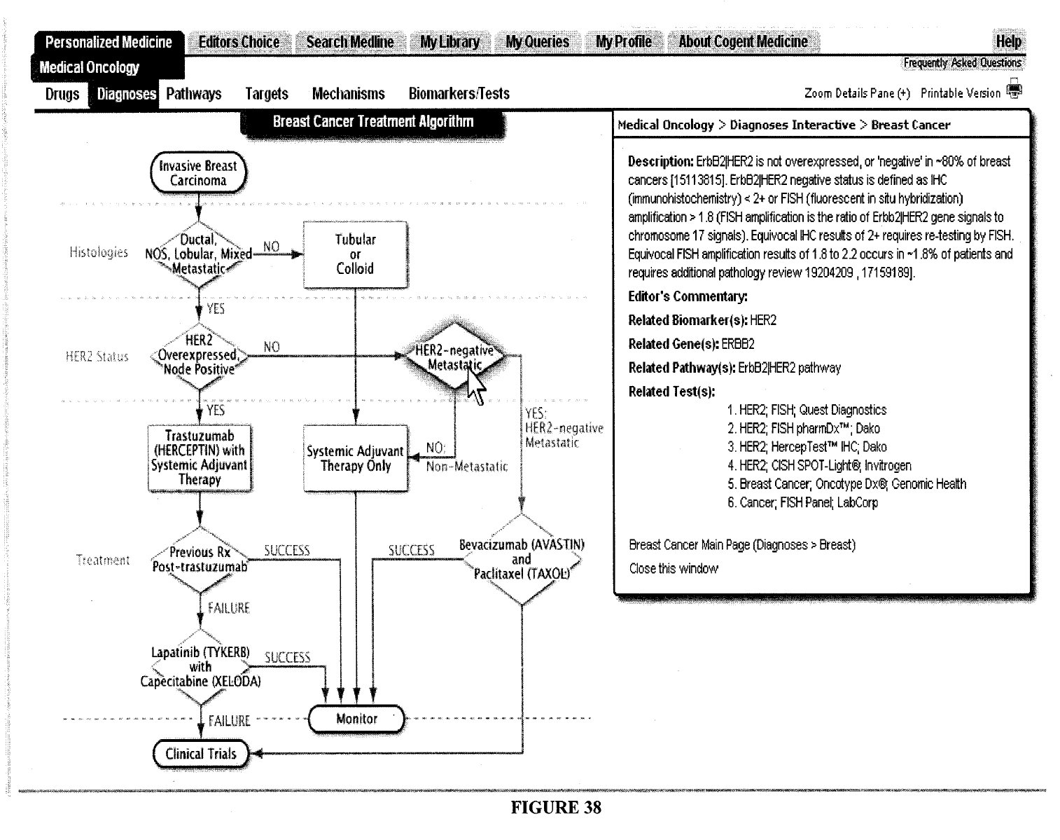

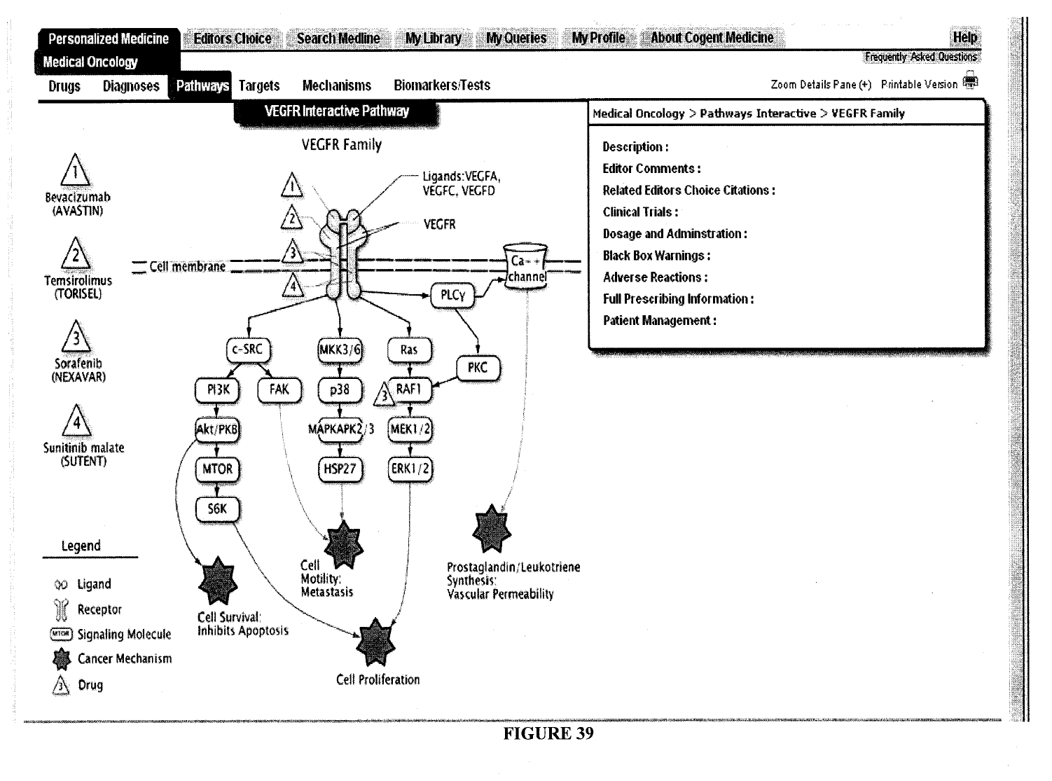

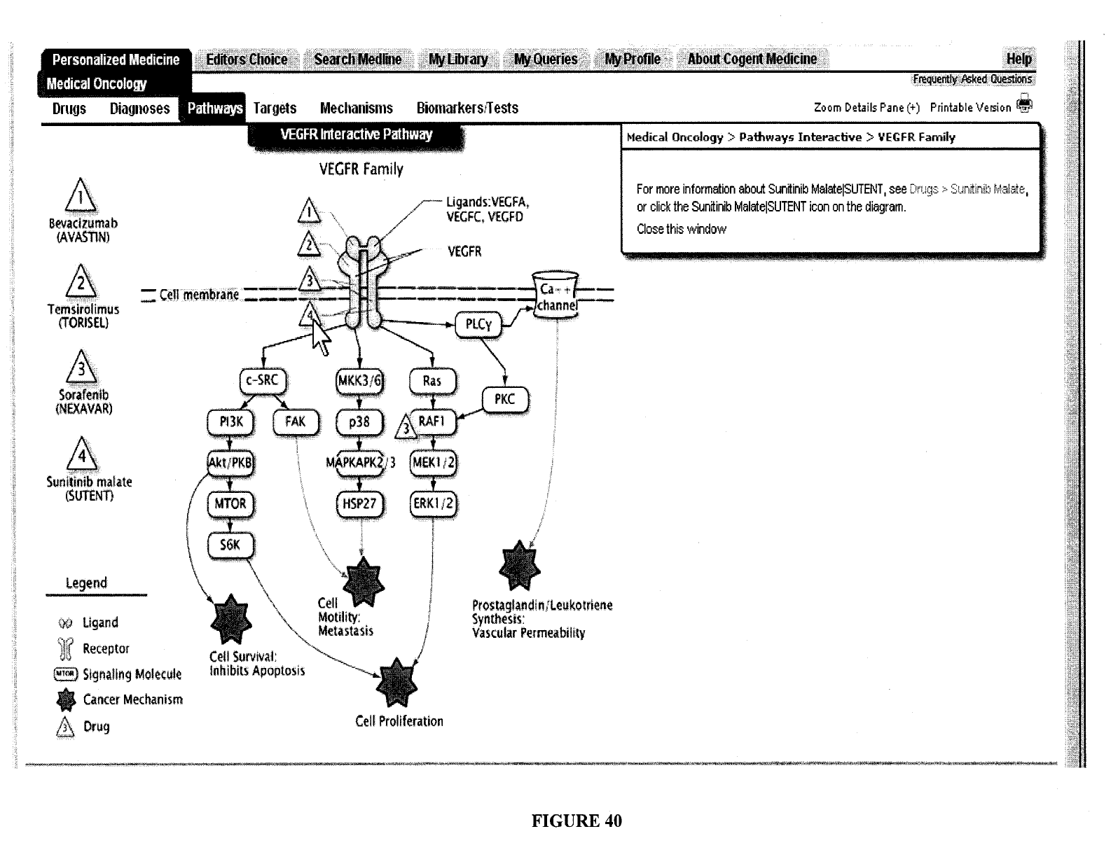

Expert commentary includes the analysis, annotation, appraisal, assessment, comparison, comment, estimate, evaluation, explanation, hypothesis, judgment, organization, proposition, recommendation, supposition, and theory of or by an expert regarding the subject represented by the graphical element and its relationship to the subject presented in the graphical representation. FIGS. 5-34, and 36-40. Expert information generally will be targeted to clinicians and other M.D. and/or Ph.D. level people, but not to people with a level of understanding equivalent to the general public. Expert commentary can be presented as textual and/or auditory information that may include graphical information. Expert commentary can be displayed on the page selected by the user or can be accessed through a link presented on the displayed page.

2.4.2 Expert-Curated Information

Expert-curated information includes information reviewed and approved by an expert and may reflect the general knowledge, current research findings, expert knowledge, or a combination of these. Expert-curated information may further include information that was gathered, selected, arranged, composed, edited, or produced by an expert. Expert-curated information may be updated by additions, deletions, or modifications to the presented information. Expert-curated information may be updated, daily, weekly, monthly, quarterly, yearly or any other recognized calendar basis. Updating can also occur during or after a symposium, meeting, scientific gathering or other academic or medically related event such as the annual meetings of the American Society of Clinical Oncology, the Radiation Research Society, or the American Society of Hematology. The expert-curated information can be modified after important announcements in the scientific or medical media or after the publication of new studies, or reviews of the scientific or medical literature.

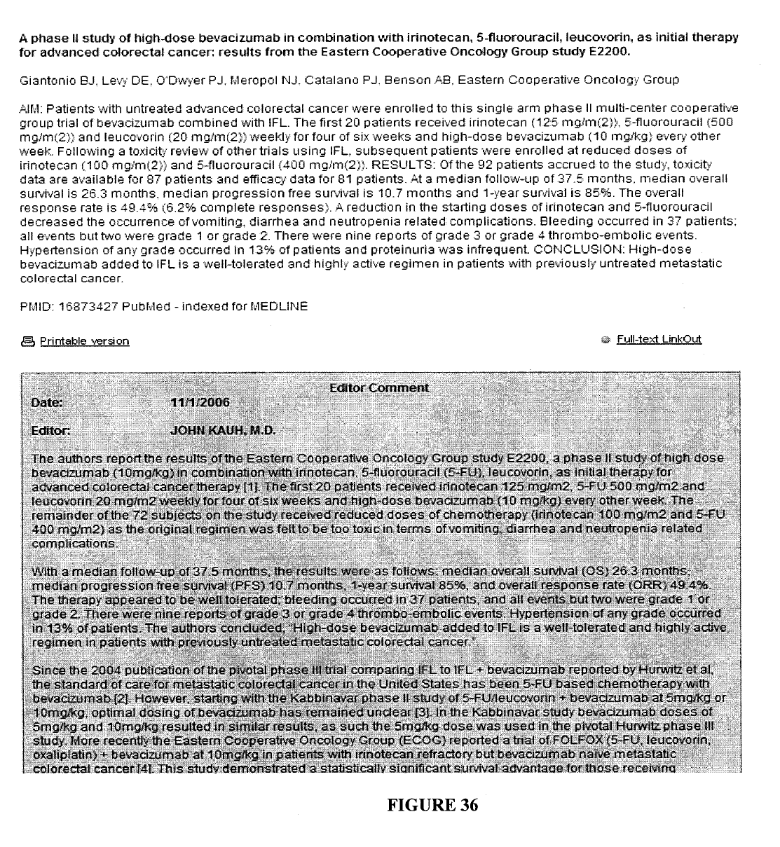

The expert-curated information can take three different forms, and the user will be presented with at least one of them. In some embodiments, the user will be presented with two or three of the different forms. The first form is that of a graphical representation, or textual or auditory presentation, that may also comprise any combination of these forms. This representation and/or presentation of expert-curated information includes information displayed or produced by a GUI. FIG. 36 is an example of expert-curated information in the form of a textual representation, in this case a citation to a clinical study. An auditory presentation may recite the textual material or it may provide an abbreviated or more comprehensive version of the material on the selected subject. Additionally, the auditory presentation may cover information not presented textual.

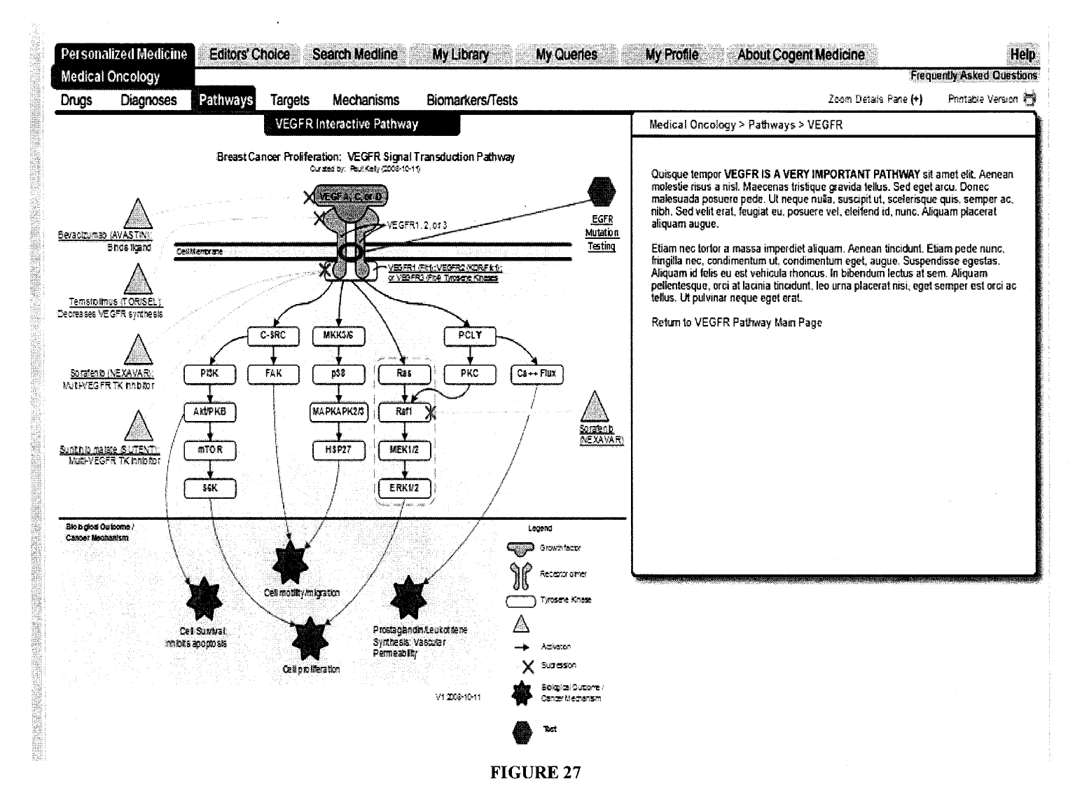

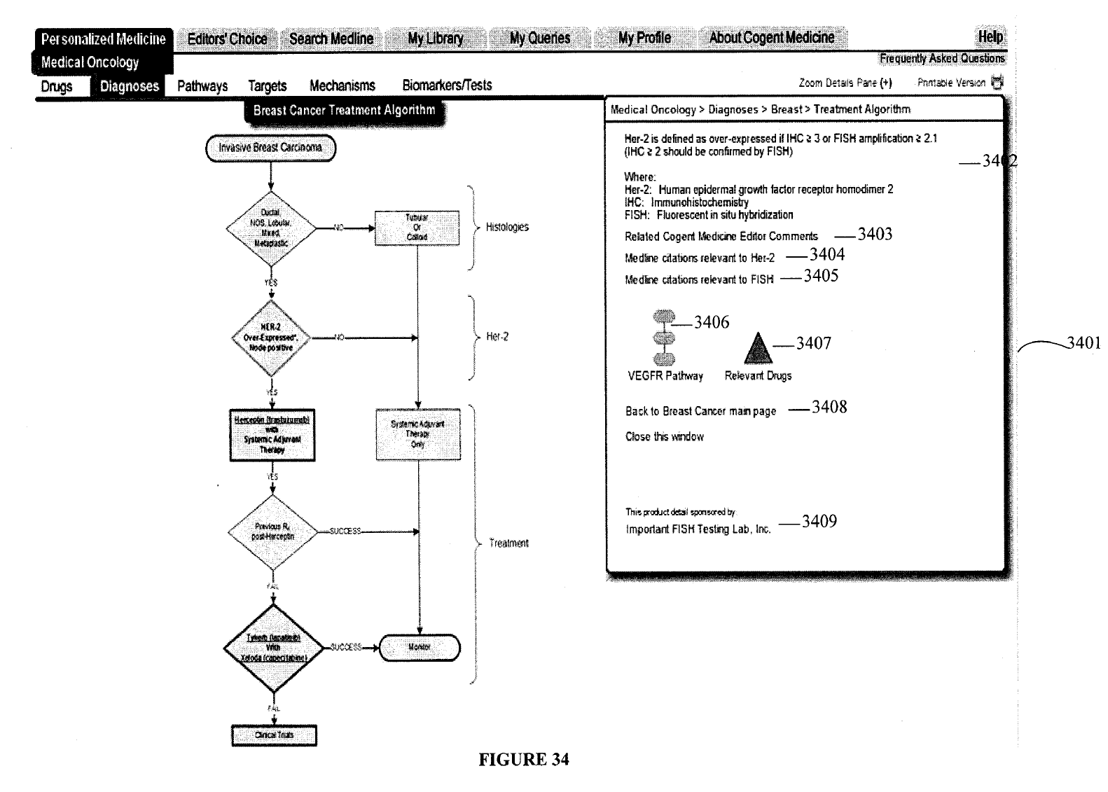

The second form is a user-selectable graphical element which, if selected, displays additional information related to the item. In some embodiments, this feature provides another layer of detail or information that can take the form of a graphical representation, or textual or auditory presentation, a user selectable graphical element which, if selected displays information relating to the item, or a linking element, which when selected produces a tertiary graphical representation or related content from within or outside the information system. As can be appreciated, this arrangement allows the user to go deeper into the nature of a specific item of interest and to explore the relationship of that item with other items present in that particular subject. For example, if a user is exploring FIG. 13 with its breast cancer treatment algorithm and desires to learn more about Her-2 over-expression, the user can select the diamond shaped user-selectable graphical element that says “HER-2 Over-Expressed Node positive.” The selection of this graphical element will display an information box FIG. 34, that contains two additional user-selectable graphical elements, VEGFR Pathway, 3406, and Relevant Drugs, 3407. If the user is interested in the VEGFR pathway, then selection of the VEGFR Pathway icon will lead to FIG. 27. Her-2 is a part of the VEGFR pathway. Alternately, the user could select the triangle to view a listing of drugs that are relevant to the treatment of Her-2 over-expressing breast cancer.

The third form is a linking element that when selected produces a graphical, textual, or auditory representation or related content from within or outside the information system. FIG. 34 illustrates a screen display with a link to content outside of the information system, in this case to the website of a FISH testing laboratory.

2.4.3 Expert Qualification and Purpose

In order to qualify as expert commentary or expert-curated information, the commentary and information must be produced by an expert in the subject of the domain. Experts typically are persons with graduate degrees in biology, medicine or a related field, for example dentistry, medicine, nursing, pharmacy, physical therapy, and/or the natural sciences. Experts are recognized for their research in the relevant area, for publishing in peer reviewed journals, for serving as a reviewer of journal articles in the area, and/or for having an academic or clinical appointment in the area. If the subject area is a specialty area within medicine, qualification as an expert may require board certification in that subject area. To produce expert knowledge, the expert relies on his or her education, experience and skill in the particular field of knowledge. In some fields of knowledge, an expert may further rely on insight and intuition gained over time in the field.

One purpose of an expert is to analyze the general state of knowledge in a field and the current research findings and from this body of knowledge synthesize new understandings. The expert may make recommendations based on the new understandings or on the new understandings in combination with known facts and relationships.

The general state of knowledge, also know as “standard knowledge” or “standard practice”, encompasses knowledge found in text books, lectures, course work, and published treatment guidelines. This type of knowledge is widely accepted and not subject to rigorous scientific dispute or controversy. Current research findings are found in contemporary journal articles, and in meeting and symposium presentations. This type of knowledge comprises new experimental data, findings, relationships and associated hypothesizes. Current research findings may expand upon the accepted theories found in the general state of knowledge or they may be a source of open scientific controversy.

The new understanding that an expert brings to a field can be in the form of new or previously unrecognized relationships, new interpretations, recommendations or conclusions that are not present in pre existing data bases, textbooks, or journal articles. In the clinical setting, the new understanding is outside settled areas of practice (standard practice) and is not found in published treatment guidelines. The new understandings incorporate elements of human intelligence and clinical inference that cannot be replicated by computerized “expert systems” or other types of artificial intelligence systems. The new understandings of an expert include textual or auditory information presented as expert commentary, and graphical, textual, and/or auditory information presented as expert-curated information.

Another purpose of the expert is to make recommendations after a review of the general state of knowledge and current research findings, but without the addition of new understandings. This situation may occur where there is a dispute as to what therapy is most beneficial to a class of patients. Clinicians may be unsure of the best course of treatment for a particular class of patients. The expert through careful and detailed analysis of known facts may be able to better explain or categorize patients or patient characteristics that do best for particular therapies and thereby provide recommendations or guidance to consider in formulating a treatment plan. Experts also identify key articles that healthcare practitioners or researches in a particular field should be aware of.

### 3. Interface

The information system has an interface that allows the user to interact with the information system. Typically, the interface is displayed on a monitor. Generally, the interface has a main menu or home page that allows the user to select a subject area of interest. In some embodiments, a user, particularly a regular user, may bookmark or save elect to jump straight to an item. Typically, the interface presents graphical, textual and/or auditory information to the user and the user can in turn communicate with or direct the actions of the information system through the use of a keyboard, computer mouse, pen or stylus, touchscreen, or voice commands. In some embodiments, a user interacts with the information system through text menus or typed commands. In some embodiments, the user interacts with the information system through a graphical user interface (GUI) that can take the form of object oriented user interface (OOUIs) or application oriented interface. In some embodiments, the user interacts with the information system through a Web based GUI. A GUI displays graphical representations composed of graphical elements that can be directly manipulated by the user as a means of communicating with the information system.

Graphical representations typically displayed by a GUI include depictions, diagrams, drawings, figures, graphs, images, illustrations, maps, pictures, representations, and schema. The graphical representations can be accompanied by related textual or auditory information or they can stand alone. FIG. 27 illustrates a graphical representation of the vascular endothelial growth factor (VEGFR) signal transduction pathways that are involved with breast cancer proliferation.

Graphical elements that comprise graphical representations displayed by GUIs generally include representational objects such as characters, marks, motifs, signs, icons, shapes, symbols, emblems, logos, representations and pictures; relationship indicators such as arrows, connectors, lines or other shapes used to illustrate movement, direction, or connection between different objects; geometric and other shapes used to illustrate relationships between objects, as in Venn diagrams; and text positioned such that its position itself is meaningful. Graphical elements may also include functional representations or objects, such as buttons, slider controls, drop down lists, pie menus, and tool bars. The represented information may concern individual graphical elements, connections between one or more graphical elements, or relation of the graphical elements to the whole concept.

Textual information includes alphanumeric characters, symbols, words, phrases, sentences, text, and numeric or textual tables, charts, or spread sheets used to convey information. Textual information may accompany a graphical representations or auditory presentation. Auditory information may take the form of spoken words, phrases, sentences, numbers, or sounds and may also accompany the graphical representations or textual presentations.

### 4. Navigation

In some embodiments, the interface presents a screen that contains a number of selectable items or icons. For example, FIG. 4 shows a screen that contains the bolded terms “Drugs,” Diagnoses”, “Pathways”, “Targets”, “Mechanisms”, “Biomarkers/Tests”, among others, that are selectable. Further, individual items, like “Tratuzumab” displayed in “Drugs” may also be selectable. Other means for accessing the material in the system include pull-down menus, pop-up boxs, details pane or window, roll over bubble, etc. In some embodiments, selection of an icon representing a topic of a first level class such as “Drugs” will display the items in that class, each of which may be selectable. In other embodiments, upon selection of an icon representing a second level class topic, the system displays items in at least one first level class. In further embodiments, as shown in FIG. 4, the system displays all of the first level class names and some contents of each class. Some contents of a class are themselves classes.

The system is set up so as to display all or part of the ontology on a user interface. Each item or class in the ontology is represented by an icon or text that, when selected, for example by clicking, tapping, or highlighting, returns icons for all items in the map for which the selected icon is the central item. The central item also includes information about the central item, which is also displayed. Each linked item also is a selectable icon which, when selected, returns items linked to it in the map in which it is the central node.

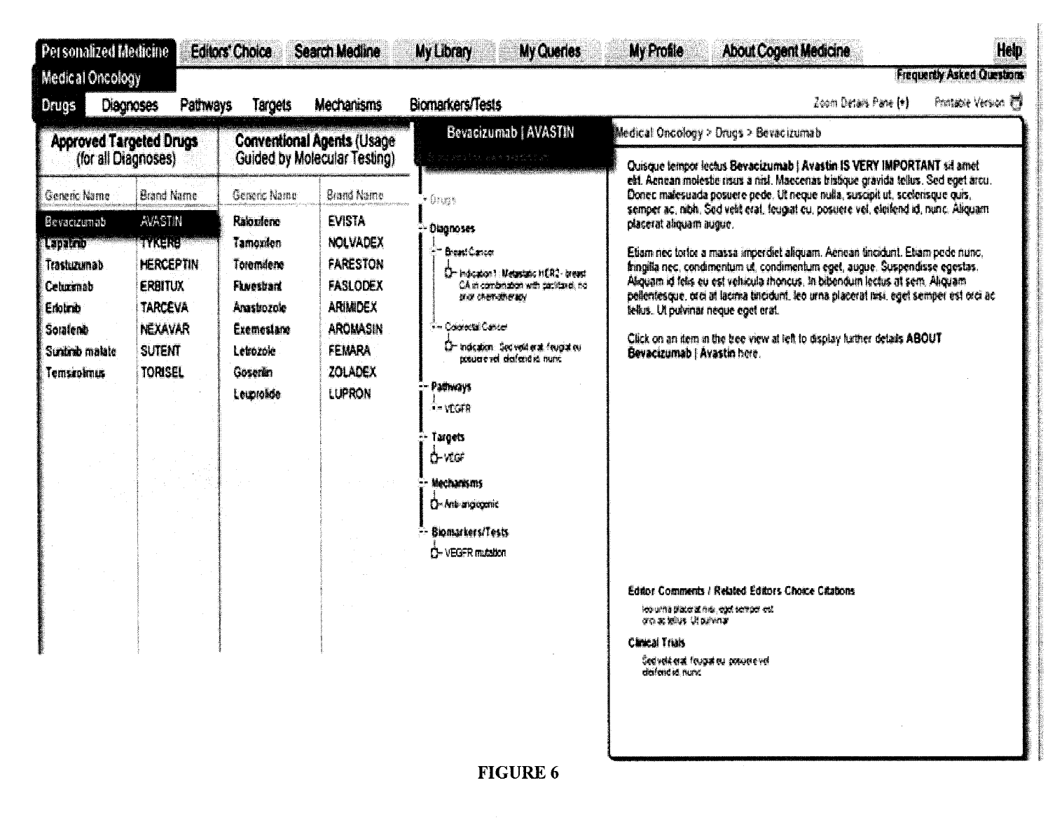

Selection of an item can display two things. First, it will display information about the item selected. For example, in FIG. 6, selection of the drug “Bevacizumab” displays a brand name for the drug (“Avastin”) as well as a pop-up box with information about the drug in the form of expert commentary. Second, selecting an item can access the map that is laid over the ontology. As mentioned, each item in the ontology is linked to a number of other items in the ontology by defined relationships. Accordingly, selection of an icon representing an item can display other items in the ontology to which the selected item is connected on the map. The selection process may be thought to function as a “filter” in which the items that are not connected on the map are “grayed out” or otherwise become unselectable or invisible. So, for example, in FIG. 6, selection of the drug Bevacizumab displays in the'center of the page the topics of the first level classes expanded to show only the items connected to Bevacizumab on the map: Diagnoses-Breast Cancer and Colon Cancer; Pathways-VEGFR; Targets-VEGF; Mechanisms-Anti-angiogenic; Biomarkers/Tests-VEGFR mutation; etc. Note that certain of the information displayed about the selected item can be displayed in connection with the item to which it is linked. For example, the indication for Bevacizumab within Breast Cancer is displayed in association with the Breast Cancer icon.

Another aspect of the present invention that makes it easy to use is the manner in which the icons connected to the selected icon are displayed. These icons, for example, “Breast Cancer” that is displayed when Bevacizumab is selected, can themselves be selectable. In one aspect, selection of a displayed icon displays information about the selected item. In another option, the system allows selection of a displayed item to further display the other items to which it is connected on the map. In this way, the user can easily navigate through the various topics to obtain information related to the topic and then obtain more detailed information about any item within the topic.

### 5. Information Display and Access

The graphical representations on a subject are arranged and displayed in an intuitive manner. In some embodiments each graphical element is clearly defined by a specific shape, color, border, or other visual representation. In some embodiments, the presence of a graphical element is indicated when a cursor on the screen touches or overlays the element. In some embodiments, the presence of a graphical element is indicated when a finger, stylus, or pen is touched to the screen. Indication of a graphical element can take many forms including a change in shape, color, or brightness of the graphical element, or a tone, sound, or spoken word. Alternately, the presence of a graphical element is indicated by the display of expert commentary and expert-curated information.

5.1 Signal Transduction Pathway

The intuitive arrangement and ease of access to information is illustrated in the graphical representation of the VEGFR signal transduction pathway diagram shown in FIG. 27. In this example, a webpage, presented, e.g., on a computer monitor, functions as an interface for the user. Breast cancer is a subject from the information structure being represented. The graphical representation shown in FIG. 27 includes numerous graphical elements, several of which can be a primary graphical element. Primary graphical elements are active or live, so that when the cursor is scrolled over a primary graphical element, or otherwise selected such as by clicking on the primary element with a mouse or tapping on the primary element on a personal digital assistant display, a bubble or other display appears on the screen or webpage. Selection of a primary graphical element by the user presents expert commentary on the item represented by the primary graphical element and expert-curated information relating the item to the subject.

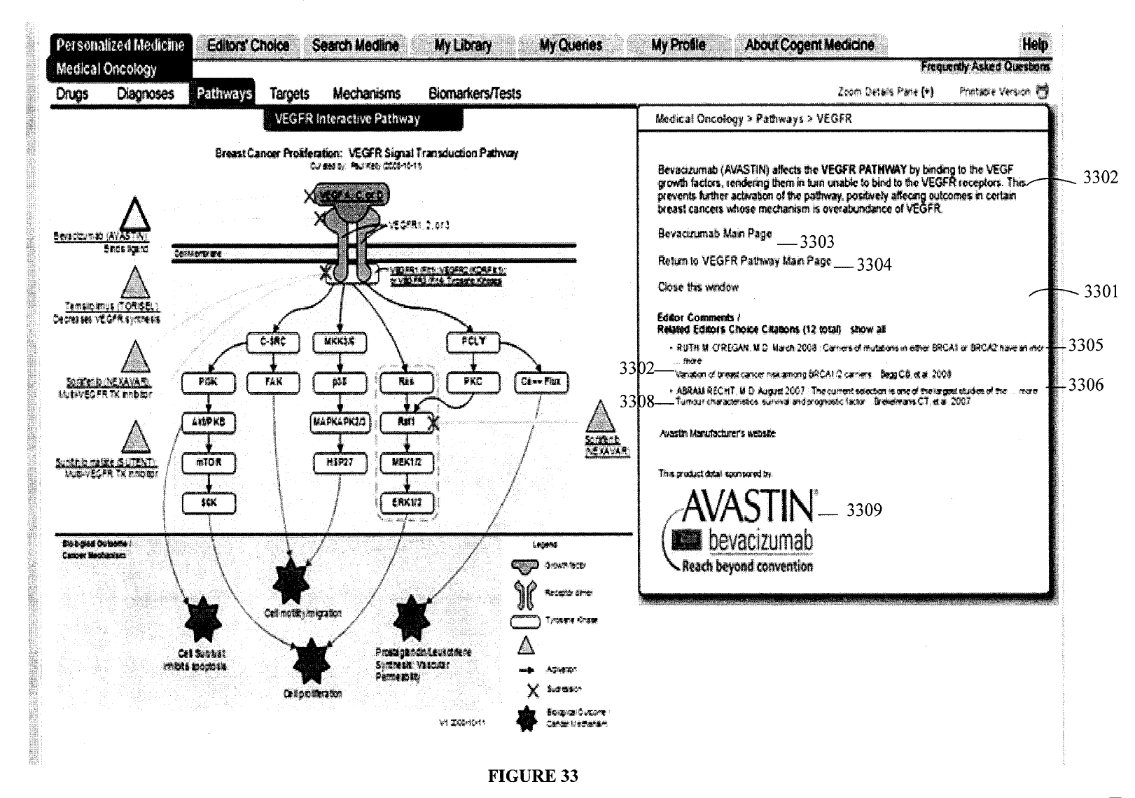

FIG. 33 illustrates the expert commentary and expert-curated information that is displayed after the primary graphical element designated “Bevacizumab” is selected from the graphical representation shown in FIG. 27. In this example, an information box, 3301, is displayed on the right side of the screen that contains expert commentary on Bevacizumab in context to the VEGFR pathway, 3302. Expert commentary may contain the most current published recommendations for prescribing Bevacizumab and may further include personal observations and recommendations from one or more experts some of which were hereto unpublished. Such recommendations may represent a synthesis of some or all publicly available data, plus guidance, suggestions and other counsel distilled from personal discussions with other leading figures in the field.

Expert-curated information can take three forms, all of which are illustrated in FIG. 33. The phrase “Bevacizumab Main Page”, 3303, is a linking element that when it is selected by the user will produce a secondary graphical representation, or a textual or auditory presentation by linking to the Bevacizumab main page that resides within the information system. Similarly, the phrase “Return to VEGFR Pathway Main Page”, 3304, is a linking element that when selected by the user will produce a secondary graphical representation, or a textual or auditory presentation by linking to the VEGFR Pathway main page that resides within the information system.

Expert-curated information in the form of a textual presentation is illustrated by the author and titles of expert selected citations, 3305 and 3306, that are relevant to Bevacizumab and the VEGFR Pathway as they relate to the personalized treatment of breast cancer. Further linking elements, 3307 and 3308, are provide that when selected by the user will produce a secondary textual presentation by directing the user to the citations that are identified in the textual presentations of 3305 and 3306, discussed above. These citations may exist within or outside of the information system. FIG. 36 illustrates a citation of a relevant publication that additionally contains further expert commentary.

The third form of expert-curated information, that of a user-selectable secondary graphical element that when selected displays additional information related to the item is illustrated by the Avastin logo, 3309. When a user selects this secondary graphical element, the user is directed to a website established by the manufacturer that contains prescribing and other information about the drug.

5.2 Treatment Algorithm

Another illustration of the intuitive manner of the information system is given in FIG. 13. This display features expert-curated information in the form of an interactive clinical treatment algorithm for invasive breast cancer and an information box that contains expert commentary on the treatment algorithm. The interactive nature of this treatment algorithm allows the development of personalized treatment plans.

The treatment algorithm can be organized as a binary decision tree composed of graphical elements. Primary graphical elements are designated by a bold outline. The first decision point on the left inquires of the histological status of the tumor specimen. The second decision point on the left seeks HER-2 expression status. This second graphical element in the shape of a diamond that says “HER-2 Over-Expressed Node positive” is a primary graphical element as indicated by its bold outline. When the user scrolls over or otherwise selects this graphical element, an information box, 3401, bubbles up on the right side of the screen that provides expert commentary and expert-curated information as shown in FIG. 34 regarding Her-2 over-expression in the context of breast cancer. Expert commentary appears in the form of a listing of the criteria for categorizing HER-2 as over-expressed by immunohistchemistry (IHC) or fluorescence in situ hybridization (FISH) analysis, 3402. Two of the three types of expert-curated information are displayed in the information box.

The phrase “Related Cogent Medicine Editor Comments” 3403, is a link that directs the user to a textual presentation, in this case, to comments regarding Her-2 expression status as it relates to breast cancer treatment. Such comments may include a discussion of testing methodologies for determining the Her-2 expression status of a breast cancer sample or a discussion of the significance of Her-2 status and treatment options. Another example of a link to a secondary textual representation is the phrase “Medline citations relevant to Her-2” 3404. This link directs the user to citations that are relevant to Her-2 that may reside within the information structure or alternatively, may reside outside of the information structure, for example on a server that is operated by the National Library of Medicine. Similarly, the phrase “Medline citations relevant to FISH”, 3405, links the user a secondary textual presentation in the form of citations that are relevant to FISH. Again, these citations may reside within or outside of the information structure.

Two examples of user-selectable secondary graphical elements that display additional information related to the item represented by a primary graphical element are shown in the information box. The first is a symbol representing the VEGFR signal transduction pathway shown as three connected hexograms, 3406. Selection of this symbol will display an interactive graphical representation of the VEGFR pathway, FIG. 27. The second user-selectable graphical element is the triangle that represents relevant drugs for the treatment of Her-2 over-expressing breast cancer, 3407. Selection of this secondary graphical element will display a listing of relevant drugs for the treatment of Her-2 over-expressing breast cancer. The phrase “Back to Breast Cancer main page”, 3408, is a linking element that when selected produces a secondary graphical representation, or textual or auditory presentation by way of displaying the main page of the section within the information system on breast cancer. A further linking element takes the user to a FISH testing laboratory's website, 3409, which resides outside of the information system.

5.3 Multiple Entry Points

The arrangement of information in the information systems allows the user the ability to enter the system at any one of numerous points and still be able to access the same desired information. This is possible because the information system cross references one subject matter and/or sub-matter to related subject matters and/or sub-matters. This allows the user to follow their intuition or interest as they search for and receive the desired information.

To further illustrate the uniform accessibility of information that can be accessed from different initial starting points in the information system, consider the following example that demonstrates how the subjects of pathophysiology, biomarkers, available and/or emerging diagnostic and/or prognostic tests, available and/or emerging therapies, and treatment algorithms can be cross referenced.

If the user first directs the information system to display a graphical representation of a pathophysiology, in this case a signal transduction pathway for invasive breast cancer, then when the user selects a primary graphical element contained in the graphical representation of invasive breast cancer, expert commentary is produced along with expert-curated information that relates the item represented by the selected graphical element to invasive breast cancer biomarkers, to the available and/or emerging diagnostic and/or prognostic tests for invasive breast cancer, to available and/or emerging therapies for invasive breast cancer, to treatment algorithms for invasive breast cancer, or a combination of these subjects.

Alternately, if the user first directs the information system to display a graphical representation of biomarkers for invasive breast cancer, then when the user selects a primary graphical element contained in the graphical representation of the biomarkers, expert commentary is produced along with expert-curated information that relates the item represented by the selected graphical element to invasive breast cancer, to available and/or emerging diagnostic and/or prognostic tests for invasive breast cancer, to treatment algorithms for invasive breast cancer, to available and/or emerging therapies for invasive breast cancer, or a combination of these.

Additionally, if the user first directs the information system to display a graphical representation of a diagnostic and/or prognostic tests for invasive breast cancer, then when the user selects a primary graphical element contained in the graphical representation of the diagnostic and/or prognostic tests, expert commentary is produced along with expert-curated information that relates the item represented by the selected graphical element to invasive breast cancer, to biomarkers for invasive breast cancer, to available and/or emerging therapies for invasive breast cancer, to treatment algorithms for invasive breast cancer, or a combination of these.

Further, if the user first directs the information system to display a graphical representation of available and/or emerging therapies for invasive breast cancer, then when the user selects a primary graphical element contained in the graphical representation of the available and/or emerging therapies for invasive breast cancer, expert commentary is produced along with expert-curated information on the relation of the graphical element to invasive breast cancer, to biomarkers for invasive breast cancer, to diagnostic and/or prognostic tests for invasive breast cancer, to treatment algorithms for invasive breast cancer, or a combination of these.

In addition, if the user first directs the information system to display a graphical representation of treatment algorithms for invasive breast cancer, then when the user selects a primary graphical element contained in the graphical representation of treatment algorithms expert commentary is produced along with expert-curated information on the relation of the graphical element to invasive breast cancer, to biomarkers for invasive breast cancer, to available and/or emerging diagnostic and/or prognostic tests for invasive breast cancer, to available and/or emerging therapies for invasive breast cancer, or a combination of these.

As the above example demonstrates, through cross referencing, the user can enter the system at any particular point among a group of related subject matters or sub matters, but is provided access to other related areas. This arrangement eliminates overly formulaic or strictly structured approaches and allows the access of information to proceed in a natural, intuitive manner and pace that is guided by the user's interest. If the user finds information in one area that is of interest, the user can easily and intuitively follow the connections to other areas that may be pertinent.

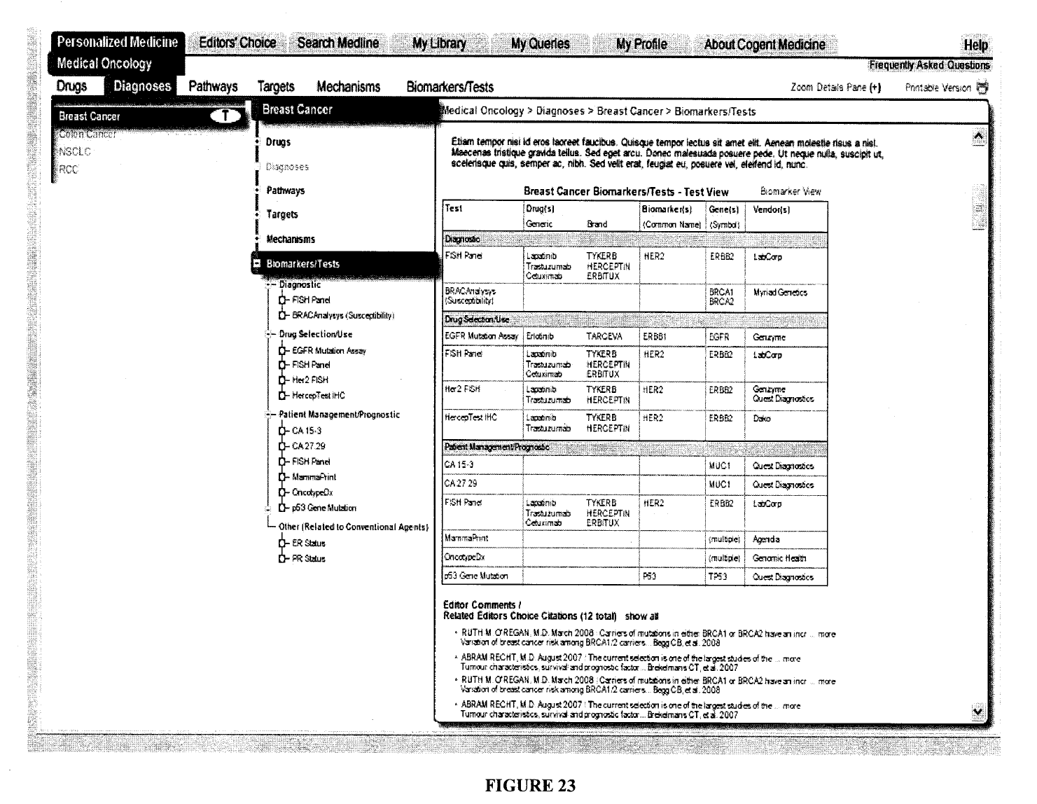

As will be apparent, FIGS. 4-34, and 36-40 have the first class level topic displayed across the screen display allowing a user to jump to any of these topics at any time. Furthermore, the items displayed in a drop down menu are selectable at any time if they are active as indicated by bold black font or some other means. For example, in FIG. 23, the drop down menu in the center of the page lists items the first level classes that have items that are relevant to Diagnosis—Breast Cancer-Biomarkers/Tests. A user can jump to any of the Biomarker/Test items that are in bold black font at anytime by selecting one of these items that are in black font. This provides an alternative navigation method to selecting an active link shown in the Breast Cancer Biomarkers/Test table shown in the information box on the right side of the screen.

5.4 Additional Levels of Information

The user selectable secondary graphical element in the produced expert-curated subject related information allows for the presentation of additionally information that relates to the subject matter. In some embodiments, the user selectable secondary graphical element comprises at least one further user selectable graphic element. Selection of the further graphic element displays additional information related to the item, a linking element that produces a further graphical representation or related content from within or outside the information system, or a combination of the above. The ability to select a further graphical element allows for the presentation of detailed and complex information to users that desire this information, without overloading, confusing, frustrating, or scaring away users that desire or need a lesser amount of information. To restate the benefit of this layered approach to information, a user is not over loaded with information when the user first accesses a subject matter or toggles between related, linked, subject matter. Rather, the user can take appropriate bites of information according to the user's desire and need.

5.5 Additional Aspects

In some aspects of the invention, instructions that allow a machine to perform the required operations of the information system are embedded in a machine readable medium. The instructions comprises directions to the machine to perform the following operations including: A) display an interface that produces a graphical representation of at least one subject in the information structure, the representation comprising at least one primary graphical element representing an item within the subject, B) accept a selection request of a primary graphical element from a user; and C) produce expert commentary on the user selected graphical element and expert-curated information related to the subject. The expert-curated information includes expert commentary on the item represented by the primary graphical element, and expert-curated information relating to the item. The expert-curated information can take the form of a graphical or textual representation, a user selectable secondary graphical element which, if selected, displays additional information related to the item, a linking element that produces a secondary graphical representation, or a textual or auditory presentation from within or outside the information system, or a combination of the above. Machine readable media includes magnetic disks, such as floppy disks and hard drives, optical disks, including CD and DVD disks, flash memory, or random access memory (RAM).

In some aspects of the invention, a method for obtaining information on subjects related to healthcare and/or biology is provided. The method comprises the steps of A) providing an information system comprising an information structure comprising information on subjects relating to healthcare and/or biology, and an interface that produces a graphical representation of at least one subject in the information structure; B) the user accessing the information system; C) the user selecting a graphical element produced by the interface; and D) the user reviewing the produced expert commentary and expert-curated information.

The graphical representation on at least one subject relating to healthcare and/or biology comprises at least one primary graphical element representing an item within the subject. Selection of the graphical element by a user produces expert commentary on the item, and expert-curated information relating to the item. The expert-curated information can take the form of a graphical representation, or textual or auditory presentation, a user selectable secondary graphical element which, if selected, displays additional information related to the item, a linking element that produces a secondary graphical representation, or textual or auditory presentation from within or outside the information system, or a combination of the above.

In some aspects of the invention, a computer system displays information produced by an information system. The information systems comprises an information structure comprising information on subjects related to healthcare and/or biology; and an interface that produces a graphical representation of at least one subject in the information structure. The graphical representation comprises of at least one primary graphical element representing an item within the subject area of interest to the user. When a graphical element is selected by a user, the information system produces expert commentary on the item, and expert-curated information relating to the item. The expert-curated information can take the form of a graphical representation, or textual or auditory presentation, a user selectable secondary graphical element which, if selected, displays additional information related to the item, a linking element that produces a secondary graphical representation, or textual or auditory presentation from within or outside the information system, or a combination of the above. The information display comprises a computer monitor, a laptop computer, a hand held device, or a mobile device, including a mobile phone.

5.6 Additional Features

In some embodiments, a personalized library is created for a user as detailed in U.S. Pat. No. 7,133,879. The personalized library provides the user with the ability to enter searches for one or more data sets and accepts user requests to view data. Data sets may be proprietary, such as the MEDLINE® database (from the National Library of Medicine). Based on the user request, the user is provided with data corresponding to the user entered search or with data preselected by an entity other than the user, such as an expert, who has reviewed data and preselected data for a particular topic or area of interest. The personalized library also can provide for automatic updating of the library contents.

In some embodiments, the ability to perform guided search queries of medical literature databases is included as detailed in U.S. Patent Application Publication No. 2005 0086078. In some embodiments, disease classification system identifiers are received from the user and translated into medical literature classification system identifiers. A medical literature database is then filtered based on relevance to evidence based medicine and medical literature articles are identified from the filtered medical literature database based on medical literature classification system identifiers. In this manner, the user only receives clinically relevant literature citations.

In some embodiments, links to information on clinical trials is provided. Information may include information about a trial's purpose, patient selection criteria, drug or device being tested, trial locations, and phone numbers for more details. In some embodiments, the link is to a registry of federally and privately supported clinical trials maintained by the U.S. National Institutes of Health.

In some embodiments, links to genetic testing facilities, drug manufacturers, device manufacturers, and/or instrumentation manufacturer are provided. In some embodiments, links to advertisers are provided. In some embodiments, links to professional, scientific, and/or healthcare associations and societies are provided.

In some embodiments, downloadable summaries of novel drugs, indications, and mechanisms are provided. These summaries are particularly useful for PDA, smart phone, and other mobile device users and allow for near instantaneous access to information even when the user is away from a desktop computer or out of range of a wireless system for laptop computers.

In some embodiments, information about genetic mutations, include official and alternate names for the gene and tests to identify a specific mutation or mutations are provided. In some embodiments, links to genetic testing facilities are provided. In some embodiments, nomenclature, map location, gene products, markers, phenotypes, sequences, variation details, expression, homologs, protein domains are provided. In some embodiments a link to Entrez Gene, a gene specific database at the National Center for Biotechnology Information (NCBI), a division of the National Library of Medicine (NLM), is provided.

5.7 Business Methods

In one aspect of the invention, business methods are provided. In some embodiments, a user is provided access to an information system comprising a database comprising an information structure comprising information on subjects related to healthcare and/or biology and an interface that produces a graphical representation of at least one subject in the information structure in exchange for financial compensation. In further embodiments, financial compensation is in the form of a subscription fee. Subscription fees include single use, daily use, weekly use, monthly use, yearly use, or various combinations of time intervals thereof. Subscriptions can also be for lifetime use. Subscriptions can be taken out by individuals, professional organizations, companies, government entities, and institutions. In some embodiments, access to the information system is free to members of professional organizations with financial compensation provided by the professional organization to the information system provider.

In some embodiments, financial compensation is provided by advertisers. Access to the information system is free to the user with fees received based on viewing of advertising displayed by the information system or by the selection “clicking” on links by users that take the user to websites maintained, sponsored, or otherwise provided by an advertiser.

In further embodiments, financial support is provided by government grants, private grants, or combinations thereof. In other embodiments, financial compensation for access is provided based on a combination of subscription fees, advertisement, grants, or combinations thereof.

5.8 Information System

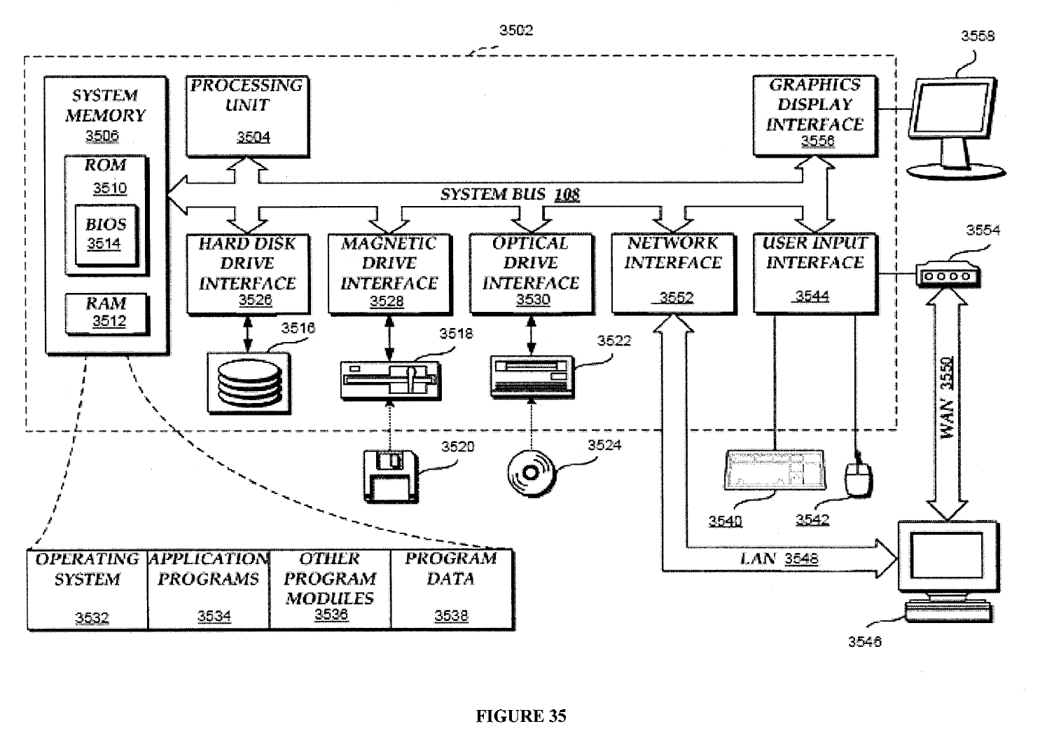

A representative computer system (or digital device) for viewing or searching data relating to the present invention is shown in FIG. 35. The computer system may be understood as a logical apparatus that can read instructions from a variety of computer media or receive instructions from a network port, which can optionally be connected to server having fixed media. FIG. 35 illustrates an example of a suitable computing system environment or architecture in which computing subsystems may provide processing functionality to execute software embodiments of the present invention, including maintaining databases comprising information structures or maps of relationships and producing a graphical representation of at least one subject in an information structure comprising of at least one primary graphical element. The method or system disclosed herein may also operational with numerous other general purpose or special purpose computing systems including personal computers, server computers, hand-held or laptop devices, multiprocessor systems, and the like.

The method or system may be described in the general context of computer-executable instructions, such as program modules, being executed by a computer. The method or system may also be practiced in distributed computing environments where tasks are performed by remote processing devices that are linked through a communications network.

With reference to FIG. 35, an exemplary system for implementing the method or system includes a general purpose computing device in the form of a computer 3502. Components of computer 3502 may include, but are not limited to, a processing unit 3504, a system memory 3506, and a system bus 3508 that couples various system components including the system memory to the processing unit 3504.

Computer 3502 typically includes a variety of computer readable media. Computer readable media includes both volatile and nonvolatile media, removable and non-removable media and a may comprise computer storage media. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices.

The system memory 3506 includes computer storage media in the form of volatile and/or nonvolatile memory such as read only memory (ROM) 3510 and random access memory (RAM) 3512. A basic input/output system 3514 (BIOS), containing the basic routines that help to transfer information between elements within computer 3502, such as during start-up, is typically stored in ROM 3510. RAM 3512 typically contains data and/or program modules that are immediately accessible to and/or presently being operated on by processing unit 3504. FIG. 35 illustrates operating system 3532, application programs 3534, other program modules 3536, and program data 3538.

The computer 3502 may also include other removable/non-removable, volatile/nonvolatile computer storage media. By way of example only, FIG. 35 illustrates a hard disk drive 3516 that reads from or writes to non-removable, nonvolatile magnetic media, a magnetic disk drive 3518 that reads from or writes to a removable, nonvolatile magnetic disk 3520, and an optical disk drive 3522 that reads from or writes to a removable, nonvolatile optical disk 3524 such as a CD ROM or other optical media. Other removable/non-removable, volatile/nonvolatile computer storage media that can be used in the exemplary operating environment include magnetic tape cassettes, flash memory cards, digital versatile disks, digital video tape, solid state RAM, solid state ROM, and the like. The hard disk drive 3516 is typically connected to the system bus 3508 through a non-removable memory interface such as interface 3526, and magnetic disk drive 3518 and optical disk drive 3522 are typically connected to the system bus 3508 by a removable memory interface, such as interface 3528 or 3530.

The drives and their associated computer storage media discussed above and illustrated in FIG. 35, provide storage of computer readable instructions, data structures, program modules and other data for the computer 3502. In FIG. 35, for example, hard disk drive 3516 is illustrated as storing operating system 3532, application programs 3534, other program modules 3536, and program data 3538. A user may enter commands and information into the computer 3502 through input devices such as a keyboard 3540 and a mouse, trackball or touch pad 3542. These and other input devices are often connected to the processing unit 3504 through a user input interface 3544 that is coupled to the system bus, but may be connected by other interface and bus structures, such as a parallel port or a universal serial bus (USB). A monitor 3558 or other type of display device is also connected to the system bus 3508 via an interface, such as a video interface or graphics display interface 3556. In addition to the monitor 3558, computers may also include other peripheral output devices such as speakers (not shown) and printer (not shown), which may be connected through an output peripheral interface (not shown).

The computer 3502 may operate in a networked environment using logical connections to one or more remote computers or analysis systems. The remote computer may be a personal computer, including a desktop or laptop computer, a PDA, a mobile device, such as a 2.5 or 3 G smart phone, a server, a router, a network PC, a peer device or other common network node, and typically includes many or all of the elements described above relative to the computer 3502. The logical connections depicted in FIG. 35 include a local area network (LAN) 3548 and a wide area network (WAN) 3550, but may also include other networks. Such networking environments are commonplace in offices, enterprise-wide computer networks, intranets and the Internet. When used in a LAN networking environment, the computer 3502 is connected to the LAN 3548 through a network interface or adapter 3552. When used in a WAN networking environment, the computer 3502 typically includes a modem 3554 or other means for establishing communications over the WAN 3550, such as the Internet. The modem 3554, which may be internal or external, may be connected to the system bus 3508 via the user input interface 3544, or other appropriate mechanism. In a networked environment, program modules depicted relative to the computer 3502, or portions thereof, may be stored in the remote memory storage device. It is envisioned that data relating to the present invention can be transmitted over such networks or connections for reception and/or review by another party.

In one embodiment of the invention, a computer system displays information produced by an information system. The information system comprises of a database comprising an information structure comprising information on subjects related to healthcare and/or biology; and an interface that produces a graphical representation. The produced graphical representation is of at least one subject in the information structure and comprises at least one primary graphical element representing an item within the subject. When a user selects a primary graphical element, displayed to the user is expert commentary on the item, and expert-curated information relating the item to the subject. This expert-curated information can take three forms, of which at least one is displayed: a graphical representation, or textual or auditorypresentation; a user selectable secondary graphical element which, if selected, display(s) additional information related to the item; or a linking element, which when selected, produces a secondary graphical representation or textual or auditory presentation from within or outside the information system.

A representative computer system of the invention can execute machine readable code that instructs the computer to at least display an interface that produces a graphical representation of at least one subject in the information structure, the representation comprising at least one primary graphical element representing an item within the subject. When a user selects a graphical element, expert commentary is displayed on the item represented by the graphical element as well as expert-curated information relating the item to the subject. This expert-curated information can be at least a graphical representation or textual or auditory presentation; a user selectable secondary graphical element which, if selected, display(s) additional information related to the item; or a linking element, which when selected, produces a secondary graphical representation or textual or auditory presentation from within or outside the information system. The executable machine readable code can further instruct the computer system to accept a selection request from the user and produce expert commentary associated with a graphical element selected by the user and expert-curated information related to the subject.

In some embodiments, machine readable code is provided. In one embodiment, the code comprises code that stores a first database comprising a plurality of items relating to a domain of medicine, wherein the items are organized in an ontology that comprises a plurality of first level classes consistent with the domain, each first level class containing items that share a common attribute consistent with the first level class; and code that stores a second database comprising a map, wherein each of the item is connected to at least one other of the items by edges defining a relationship between the connected items. In a further embodiment, the machine readable medium also comprises of code that displays on an interface at least one element representing an item in the first database, wherein selection of the element causes display of elements representing items in the map to which the selected item is connected by an edge.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

What is claimed is:

1. An information system comprising:
(a) a database comprising an information structure comprising information on subjects related to healthcare and/or biology; and
(b) an interface that produces a graphical representation of at least one subject in the information structure, the representation comprising at least one primary graphical element representing an item within the subject, wherein selection of the primary graphical element by a user produces:
(i) expert commentary on the item, and
(ii) expert-curated information relating the item to the subject in the form of at least one of the following:
(1) a graphical representation, or textual or auditory presentation;
(2) a user selectable secondary graphical element which, if selected, displays additional information related to the item; or
(3) a linking element, which when selected, produces a secondary graphical representation or a textual or auditory presentation from within or outside the information system.

2. The information system of claim 1, wherein information on subjects related to healthcare information comprises information on at least one of dentistry, medicine, nursing, pharmacy, and physical therapy.

3. The information system of claim 2, comprising information on medicine, wherein information on medicine further comprises information on pathophysiologies, diagnostic and/or prognostic tests, therapeutic modalities, treatment algorithms, and/or drug responsiveness.

4. The information system of claim 3, comprising information on pathophysiologies wherein information on pathophysiologies further comprises information on prepathologic conditions, malignancies, autoimmune diseases, infectious diseases, inflammatory diseases, psychiatric disorders, or neurological diseases.

5. The information system of claim 3, comprising information on pathophysiologies, wherein in information on pathophysiologies further comprises information on conditions that predispose an individual to a pathophysiology, including the contribution of acquired or inherited genetic variance.

6. The information system of claim 4, comprising information on malignancies wherein information on malignancies further comprises information on pre malignant conditions and/or information on malignant conditions.

7. The information system of claim 3, comprising information on diagnostic and/or prognostic tests wherein information on diagnostic and/or prognostic tests further comprises the assessment of biomarkers, standard laboratory tests, medical imaging, and/or physical examination.

8. The information system of claim 3, comprising information on therapeutic modalities wherein information on therapeutic modalities further comprises information on drugs, radiotherapy, surgery, transplantation, genetic therapy, psychiatric and other counseling, and/or physical therapy.

9. The information system of claim 8, comprising information on drugs, wherein information on drugs further comprises information on small molecules, biologics, natural products, and derivatives and combinations thereof.

10. The information system of claim 1, wherein information on subjects related to biology comprises information on normal and abnormal cells, tissues, organs, organ systems, immunologic and cognitive/behavioral function.

11. The information system of claim 1, wherein the at least one primary graphical representation produced by said interface is expert-curated.

12. The information system of claim 1, wherein the interface includes a graphical user interface.

13. The information system of claim 3, wherein said graphical representation produced by said interface is of a pathophysiology.

14. The information system of claim 13, wherein selection of a primary graphical element by a user produces expert-curated information relating to at least one of the following:
(a) relation of the item represented by the graphical element to biomarkers;
(b) relation of the item represented by the graphical element to the available and/or emerging diagnostic and/or prognostic tests;
(c) relation of the item represented by the graphical element to available and/or emerging therapies; or
(d) relation of the item represented by the graphical element to treatment algorithms for said pathophysiology.

15. The information system of claim 3, wherein said graphical representation produced by said interface is of biomarkers.

16. The information system of claim 15, wherein selection of a primary graphical element by a user produces expert-curated information relating to at least one of the following:
(a) relation of the item represented by the graphical element to a pathophysiology;
(b) relation of the item represented by the graphical element to available and/or emerging diagnostic and/or prognostic tests;
(c) relation of the item represented by the graphical element to treatment algorithms; or
(d) relation of the item represented by the graphical element to available and/or emerging therapies.

17. The information system of claim 3, wherein said graphical representation produced by said interface is of diagnostic and/or prognostic tests for a pathophysiology.

18. The information system of claim 17, wherein selection of a primary graphical element by a user produces expert-curated information relating to at least one of the following:
(a) relation of the item represented by the graphical element to said pathophysiology;
(b) relation of the item represented by the graphical element to biomarkers;
(c) relation of the item represented by the graphical element to available and/or emerging therapies; or
(d) relation of the item represented by the graphical element to treatment algorithms.

19. The information system of claim 3, wherein said graphical representation produced by said interface is of available and/or emerging therapies.

20. The information system of claim 19, wherein selection of a primary graphical element by a user produces expert-curated information relating to at least one of the following:
(a) relation of the item represented by the graphical element to a pathophysiology;
(b) relation of the item represented by the graphical element to biomarkers;
(c) relation of the item represented by the graphical element to diagnostic and/or prognostic tests; or
(d) relation of the item represented by the graphical element to treatment algorithms.

21. The information system of claim 3, wherein said graphical representation produced by said interface is of treatment algorithms.

22. The information system of claim 21, wherein selection of a primary graphical element by a user produces expert-curated information relating to at least one of the following:
(a) relation of the item represented by the graphical element to a pathophysiology;
(b) relation of the item represented by the graphical element to biomarkers;
(c) relation of the item represented by the graphical element to available and/or emerging diagnostic and/or prognostic tests; or
(d) relation of the item represented by the graphical element to available and/or emerging therapies.

23. The information system of claim 1, wherein the user selectable secondary graphical element in the produced expert-curated subject related information comprises further user selectable graphic elements comprising one or more of the following:
(a) a graphical representation, or textual or auditory presentation;
(b) a user selectable graphical element which, if selected, displays information relating to the item; or
(c) a linking element, which when selected, produces a tertiary graphical representation or textual or auditory presentation from within or outside the information system.

24. A method for obtaining information on subjects related to healthcare and/or biology comprising:
(a) providing a database comprising an information system comprising:
(i) an information structure comprising information on subjects relating to healthcare and/or biology; and
(ii) an interface that produces a graphical representation of at least one subject in the information structure, the representation comprising at least one primary graphical element representing an item within the subject, wherein selection of the graphical element by a user produces:
(1) expert commentary on the item, and
(2) expert-curated information relating the item to the subject in the form of at least one of the following:
a) a graphical representation or textual or auditory presentation;
b) a user selectable secondary graphical element which, if selected, display(s) additional information related to the item; or
c) a linking element, which when selected, produces a secondary graphical representation, or textual or auditory presentation from within or outside the information system.
(b) accessing said information system;
(c) selecting a graphical element produced by said interface; and
(d) reviewing the produced expert commentary and expert-curated information.

25. A system comprising:
(a) a first database comprising a plurality of items relating to a domain of medicine, wherein the items are organized in an ontology that comprises a plurality of first level classes consistent with the domain, each first level class containing items that share a common attribute consistent with the first level class;
(b) a second database comprising a map, wherein each of the item is connected to at least one other of the items by edges defining a relationship between the connected items; and
(c) an interface configured to display at least one element representing an item in the first database, wherein selection of the element causes display of elements representing items in the map to which the selected item is connected by an edge.

26. The system of claim 25 wherein the organization of the ontology is constrained by an expert in the domain.

27. The system of claim 26 wherein each item is associated with content relating to the subject and the content is constrained by an expert in the subject.

28. The system of claim 25 wherein the domain of medicine is clinical medicine.

29. The system of claim 26 wherein the ontology comprises a plurality of second level classes, wherein each second level class:
(i) is consistent with the domain, and
(ii) contains a plurality of items that share a common attribute consistent with the second level class.

30. The system of claim 29 wherein the second level classes include a plurality of subjects directed to a medical specialty.

31. The system of claim 29 wherein the first level classes include a plurality of subjects related to the practice of clinical medicine including at least one selected from disease diagnosis, pharmaceuticals, disease pathways, treatment modalities, biomarkers; molecular targets, drug mechanisms-of-action, drug mechanisms-of-toxicity, diagnostic patient management tests and prognostic patient management tests.

32. The system of claim 31 wherein the first level classes include at least pharmaceuticals, disease diagnosis and biochemical pathway and an item in the pharmaceutical class is connected to an item in the diagnosis class for which the pharmaceutical, and is connected to an item in the biochemical pathway class that contain targets for the pharmaceutical.

33. The system of claim 31 wherein the first level classes include at least pharmaceuticals, disease diagnosis and biochemical pathway and an item in the disease diagnosis class is connected to an item in the pharmaceutical class used in treatment of the disease, and is connected to an item in the biochemical pathway class that is involved in disease pathology.

34. The system of claim 31 wherein the first level classes include at least pharmaceuticals, disease diagnosis and biochemical pathway and an item in the disease pathway class is connected to an item in the diagnosis class in which the pathway is implicated, and is connected to an item in the pharmaceutical class that target elements of the biochemical pathway.

35. The system of claim 25 wherein selecting an element representing an item also displays information about the item.

36. The system of claim 26 wherein the interface displays elements representing a plurality of the first level classes, wherein selecting an element that represents a first level class displays elements representing the items contained within the first level class.

37. The system of claim 26 wherein the interface displays elements representing a plurality of second level classes, wherein selecting an element representing a second level class displays elements representing the first level classes contained within the second level class.

38. The system of claim 25 wherein the elements representing related items, when selected, causes display of elements representing related items in a map in which the item of the selected element is the central node.

39. A method comprising:
(a) providing a first database comprising a plurality of items relating to a domain of medicine, wherein the items are organized in an ontology that comprises a plurality of first level classes consistent with the domain, each first level class containing items that share a common attribute consistent with the first level class;
(b) providing a second database comprising a map, wherein each of the item is connected to at least one other of the items by edges defining a relationship between the connected items; and
(c) providing an interface configured to display at least one element representing an item in the first database, wherein selection of the element causes display of elements representing items in the map to which the selected item is connected by an edge.
